(19) United States
(12) Patent Application Publication
(10) Pub. No.: US 2026/0311981 A1
(43) Pub. Date: Oct. 8, 2026

(54) MASS SPECTROMETRY CALIBRATION

(71) Applicant: Micromass UK Limited, Wilmslow (GB)

(72) Inventor: Keith George Richardson, High Peak (GB)

(73) Assignee: Micromass UK Limited, Wilmslow (GB)

(21) Appl. No.: 19/639,948

(22) Filed: Apr. 6, 2026

Related U.S. Application Data
(60) Provisional application No. 63/784,669, filed on Apr. 7, 2025.

(51) Int. Cl. H01J 49/00

(52) U.S. Cl. CPC H01J 49/0009; H01J 49/0036

(57) ABSTRACT

A method of calibrating a charge detection mass spectrometer, comprising: analysing ions of one or more calibrant species using said charge detection mass spectrometer so as to obtain data representative of the mass to charge ratios of the ions, where a minimum mass is known for an ion of each calibrant species; and using said data, said minimum mass, and an additional mass value representing a mass that may be attached to each of the one or more calibrant species during said analysing to determine a calibration parameter that relates data obtained when analysing a given ion species using said charge detection mass spectrometer to its mass to charge ratio.

### CROSS-REFERENCE TO RELATED APPLICATION

This application claims priority from and the benefit of U.S. Provisional Patent Application No. 63/784,669 filed on Apr. 7, 2025. The entire contents of this application are incorporated herein by reference.

### FIELD OF THE INVENTION

The present invention relates generally to mass spectrometry, and techniques for calibrating mass spectrometers.

### BACKGROUND

In charge detection mass spectrometry (CDMS) ions are caused to oscillate and their frequencies of oscillation are detected and used to determine their mass to charge ratios. In particular, the mass to charge ratio of an ion is generally assumed to be proportional to the inverse of the square of its oscillation frequency. In order to calibrate a charge detection mass spectrometer, it is therefore necessary to determine the constant of proportionality between mass to charge ratio and the inverse of the square of oscillation frequency. However, conventional techniques for performing such calibration tend to be relatively inaccurate.

### SUMMARY

From a first aspect, the present invention provides a method of calibrating a charge detection mass spectrometer, comprising: analysing ions of one or more calibrant species using said charge detection mass spectrometer so as to obtain data representative of the mass to charge ratios of the ions, where a minimum mass is known for an ion of each calibrant species; and using said data, said minimum mass, and an additional mass value representing a mass that may be attached to each of the one or more calibrant species during said analysing to determine a calibration parameter that relates data obtained when analysing a given ion species using said charge detection mass spectrometer to its mass to charge ratio.

In order to obtain an accurate calibration parameter that relates data obtained when analysing a given ion species to its mass to charge ratio, according to conventional techniques it is necessary to accurately know the masses and charge states of the calibrant species being analysed. However, it has been recognised that conventional calibration techniques may obtain calibration parameters that are inaccurate, and that have unknown uncertainties in their accuracy, due to the fact that the calibrant species may have additional masses attached to them when they are being analysed. For example, solvent or other adducts may be attached to the calibrant species when they are being analysed. The present invention accounts for these additional masses when determining the calibration parameter and therefore is able to provide a more precise and accurate calibration parameter, along with well-defined uncertainties in its value.

For the avoidance of doubt, although the term “mass to charge ratio” of an ion is sometimes inaccurately referred to as “mass”, these terms are not used interchangeably herein. Rather, as the term suggests, “mass to charge ratio” is the mass of an ion divided by its charge.

The minimum mass for each of the calibrant species may be its theoretical mass value determined from its molecular structure.

Each of the one or more calibrant species may be a protein or peptide. The minimum mass for each of the one or more calibrant species may be the sequence mass for the protein or peptide.

Said analysing ions of one or more calibrant species may comprise analysing ions of multiple different calibrant species so as to obtain said data.

It is advantageous to use data from multiple, such as several, different calibration species during the calibration method, where each calibration species has a different minimum mass, as this helps to constrain the calibration parameter.

The multiple different calibrant species may mixed together in the same solution, the solution may then be ionised and the resulting ions subjected to said analysing so as to obtain said data, e.g. in a single experiment. Alternatively, each of the multiple different calibrant species may be provided in its own respective solution, and these solutions may be separately ionised and the resulting ions separately subjected to said analysing so as to obtain said data, e.g. in multiple separate experiments.

The step of analysing ions of said one or more calibrant species may comprise analysing a single ion, or analysing a plurality of ions, of each calibrant species.

At least one charge state of the ions of each calibrant species analysed may be known, and the at least one charge state may be used, along with the corresponding minimum mass, additional mass value, and data from said analysing step to determine the calibration parameter.

At least one of said one or more calibrant species may have ions of multiple different charge states that are analysed in said analysing step. These different charge states may be known or unknown. Accordingly, at least one of said one or more calibrant species may have ions of multiple different charge states that are analysed in said analysing step, wherein said multiple different charge states are known and used, along with their respective minimum mass, respective additional mass value, and respective data from said analysing step, to determine the calibration parameter.

All ions of a given calibrant species may be considered to have the same additional mass; and/or ions of different calibrant species may be considered to have respective additional masses that are different from each other.

In the embodiments in which ions of a plurality of calibrant species are analysed, where each calibrant species has ions of multiple different charge states, the range of known charge states may be different for each calibrant species.

It will be appreciated that in these embodiments the values of the data, minimum mass and at least one charge state are known, but the true value of the calibration parameter is unknown and the true value of the additional mass may also be unknown.

Said analysing ions may comprise causing each ion to oscillate in an ion trap and measuring the frequency at which the ion oscillates so as to obtain said data representative of the mass to charge ratio of the ion.

Said measured data may be said frequency, wherein said mass to charge ratio may be equal to the product of a constant k and the inverse of the square of said frequency, wherein said calibration parameter is said constant k.

It will therefore be appreciated that the constant k is unknown prior to the calibration method being performed.

Alternatively, said mass to charge ratio may be equal to the inverse of a first constant g multiplied by a second constant ko, multiplied by the inverse of the square of said frequency, where the data is a value determined based on said frequency and said second constant ko, and where said calibration parameter is said constant g.

In this embodiment the constant ko is a value that is selected or known prior to the calibration method being performed. The second constant ko may be a provisional value for the constant of proportionality between mass to charge ratio and the inverse of the square of the frequency, and the product of the inverse of the first constant g and the second constant ko is a modified value for said constant of proportionality. Providing such a provisional value allows measured ion frequencies to be immediately translated into provisional mass to charge ratio measurements, thus facilitating their comparison with theoretical mass to charge ratio values for each charge state of each calibrant species. The second constant ko may be a value based on, for example, the physics of an ideal theoretic ion trap. Alternatively, the provisional value may be a value for said constant of proportionality that has been obtained previously for the ion trap being calibrated. Alternatively, the provisional value may be a value for said constant of proportionality for another calibrated ion trap having the same or similar design. Alternatively, the provisional value may be an estimated value of the constant of proportionality.

The method mat comprise: providing a model that relates said data to parameters representing: (i) said minimum mass of each calibrant species, (ii) said additional mass for each calibrant species, (iii) at least one charge state for ions of each calibrant species, and (iv) said calibration parameter; specifying a function that provides a likelihood, or goodness of fit, of the model to the data for a given set of values for said parameters; and using said model, said function and said data to determine a value of the calibration parameter, optionally together with a value for the uncertainty associated with this determined value of the calibration parameter.

Optionally, the model may relate said data to a value representing the mass of each charge carrier that gives rise to the charge state, such as the mass of a proton.

The method may trial, e.g. iteratively, different values for the parameters until a likelihood or goodness of fit is achieved that is above a threshold value, or until a maximum likelihood or goodness of fit is achieved. The value of the calibration parameter, and optionally the value for the uncertainty, may then be determined using the model, the data and these values of the parameters.

The at least one charge state may be known and included in the model accordingly. If different calibrant species are analysed then the range of known charge states may be different for the different calibrant species.

Alternatively, the at least one charge state may be unknown and the method may involve trialling different values for the at least one charge state until the likelihood or goodness of fit is achieved that is above a threshold value, or until a maximum likelihood or goodness of fit is achieved. The value(s) of the charge state(s) that provide this likelihood or goodness of fit may then be determined as being the charge states of the ions.

The method may comprise using a Bayesian approach to determining the calibration parameter.

The value of the parameter representing said additional mass for each calibrant species may be unknown, and a first prior probability distribution may be provided for this parameter.

This first prior probability distribution represents the initial state of knowledge for the value of additional mass, e.g. before analysing the calibration data. For example, the first prior probability distribution may reflect that the values of this parameter must be positive, since they represent masses.

The true value of the calibration parameter is unknown, at least prior to the calibration being performed. Accordingly, the value of the calibration parameter is unknown, and a second prior probability distribution may be provided for this parameter.

This second prior probability distribution represents the initial state of knowledge for the value of the calibration parameter, e.g. before analysing the calibration data. For example, in embodiments where the calibration parameter is said first constant g, the prior probability distribution is expected to be close to a value of 1.

The method may comprise determining a joint probability distribution for the data and the parameters representing said additional mass for each calibrant species and said calibration parameter.

The method may comprise removing the parameters representing said additional mass for each calibrant species from the joint probability distribution by integrating over them so as to obtain an expression for a modified joint probability distribution in which the only parameter having an unknown value is said calibration parameter. As will be appreciated in the art, this process is known as marginalisation and it may be used to marginalise the parameters representing said additional mass for each calibrant species out of the posterior probability distribution. The effect of this process is that all possible values for the additional mass parameters are taken into account when making inferences about the calibration parameter.

The step of using said model, said function and said data to determine a value of the calibration parameter may comprise extracting inferences about the calibration parameter from the modified joint probability distribution.

The method may comprise calculating the properly normalised posterior probability distribution for the calibration parameter.

Said extracting inferences about the calibration parameter from the modified joint probability distribution may comprise: (i) using the modified joint probability distribution directly to numerically calculate a representative inferred value for the calibration parameter together with a measure of uncertainty; or (ii) sampling values of the calibration parameter from the modified joint probability distribution.

According to option (i), the numerically calculated representative inferred value for the calibration parameter may be a mean, or maximum a posteriori value.

The method may also use the modified joint probability distribution to numerically calculate a measure of uncertainty in the inferred value for the calibration parameter, such as a standard deviation, confidence interval, or interquartile range.

According to option (ii), the sampling may be formed using a Markov Chain Monte Carlo method or nested sampling.

The method may comprise using said model, said function and said data to generate an inferred value for each of the parameters representing said additional mass for each calibrant species, optionally together with a value for the uncertainty associated with this determined value of additional mass.

The first aspect of the present invention also provides a method of charge detection mass spectrometry comprising: providing a charge detection mass spectrometer; determining a calibration parameter that relates data obtained by the mass spectrometer when analysing a given ion species to its mass to charge ratio by performing a method of calibrating a charge detection mass spectrometer as described above; analysing at least one ion of one or more further ion species in the mass spectrometer so as to obtain data representative of the mass to charge ratio of the at least one ion; and determining the mass to charge ratios of said at least one ion using said data for said at least one ion and said calibration parameter.

The one or more further ion species may have an unknown mass and/or mass to charge ratio, and/or an unknown charge, prior to being analysed by the mass spectrometer.

The method may further comprise using the mass spectrometer to measure the charge states of said at least one ion, and determining the mass of each ion from the mass to charge ratio and charge state determined for it.

The mass spectrometer may analyse the at least one ion in the same manner as described above for the calibrant species, e.g. by causing each ion to oscillate in an ion trap and measuring the frequency at which the ion oscillates so as to obtain said data representative of the mass to charge ratio of the ion.

The mass spectrometer may analyse the at least one ion by causing each ion to repeatedly oscillate past a charge sensitive detector such that the charge of the ion repeatedly induces a signal on the detector. The spectrometer may determine the frequency at which the ion oscillates from said signal and/or determine the charge state of the ion from a magnitude of the signal. For example, in order to determine the frequency at which the ion oscillates, the signal may be transformed from the time-domain to the frequency-domain, e.g. using a Fourier Transform, and the frequency at which the ion oscillates may be determined from a frequency of the signal in the frequency-domain.

The present invention also provides a computer implemented method for performing the method described above.

Accordingly, the first aspect of the present invention provides a computer implemented method for calibrating a charge detection mass spectrometer comprising: receiving data representative of the mass to charge ratios of ions of one or more calibrant species, along with a known minimum mass for the ions of each calibrant species; and using said data, said minimum mass, an and additional mass value representing a mass that may be attached to each of the one or more calibrant species during said analysing to determine a calibration parameter that relates data obtained when analysing a given ion species using said charge detection mass spectrometer to its mass to charge ratio.

The computer implemented method have any of the features described above in relation to the method of calibrating the charge detection mass spectrometer.

The first aspect of the present invention also provides a charge detection mass spectrometer configured to perform any of the above methods.

Accordingly, the present invention provides a charge detection mass spectrometer comprising: an analyser for analysing ions of one or more calibrant species so as to obtain data representative of the mass to charge ratios of the ions; and control circuitry configured to control the mass spectrometer to: access known values for a minimum mass for the ions of each of said calibrant species; and use said data, said minimum mass, and an additional mass value representing a mass that may be attached to each of the one or more calibrant species during said analysing to determine a calibration parameter that relates data obtained when analysing a given ion species using said charge detection mass spectrometer to its mass to charge ratio.

The mass spectrometer may have a user interface configured to allow a user to input or select the identities of the one or more calibrant species to be analysed. The control circuitry may be configured to access, in response to the input or selection, known values for the minimum mass for the ions of each of these calibrant species. These values may be stored in a memory in the spectrometer.

The spectrometer may also access an expected value for the additional mass that may be attached to each of the one or more input or selected calibrant species. These values may be stored in a memory in the spectrometer or generated based on the calibrant species that have been input or selected.

According to a second aspect of the present invention there is provided a method of calibrating a charge detection mass spectrometer, comprising: analysing ions of one or more calibrant species using said charge detection mass spectrometer so as to obtain a data pair for each ion that is detected, where the data pair comprises a first value related to the mass to charge ratio of the ion and a second value related to the charge of the ion; arranging the data pairs as spectral data that represents the abundance of ions as a function of the first value related to mass to charge ratio; and performing mass to charge ratio peak locating on said spectral data by using a model that relates said spectral data to a set of parameters.

As the present invention uses the model it is able to account for the additional mass that may attach to each ion, and the effect of the additional mass on the shape, width and position of the mass to charge ratio peaks. This enables relatively accurate calibration.

The method may be performed multiple times on ions of multiple respective calibrant species. The resulting mass to charge ratio values may then be used to calibrate the mass spectrometer.

The model may relate said spectral data to a set of parameters that includes one or more parameters that represent the mass for each ion of each calibrant species and a parameter that relates the first value measured by the spectrometer to a mass to charge ratio value.

The mass and parameter that relates the first value measured by the spectrometer to mass to charge ratio may be represented by a single parameter or by separate parameters. The mass parameter may include the unknown additional mass, or the unknown additional mass may be a further parameter.

Each of the one or more calibrant species may be a protein or peptide.

Said analysing ions may comprise analysing ions of multiple different calibrant species so as to obtain said data pairs.

The ions may be analysed as described in relation to the first aspect of the present invention. For example, said analysing ions may comprise causing each ion to oscillate in an ion trap and measuring the frequency at which the ion oscillates so as to obtain said first value. The magnitude of the signal may be measured to determine said second value.

At least one of said one or more calibrant species may have ions of multiple different charge states that are analysed in said analysing step. Accordingly, each of said one or more calibrant species has ions of multiple different charge states that are analysed in said analysing step.

The peak locating may therefore detect or locate the positions of different mass to charge ratio peaks for different respective charge states of each calibrant species.

The method may comprise: specifying a function that provides a likelihood, or goodness of fit, of the model to the spectral data for a given set of values for said parameters; and using said model, said function and said spectral data to determine a set of values for said parameters that fit the model to the spectral data.

The step of using said model, said function and said spectral data may also determine the uncertainties in said set of values for said parameters that fit the model to the spectral data.

The step of using said model, said function and said spectral data may comprises varying said set of values, e.g. iteratively, until a likelihood or goodness of fit is achieved that is above a threshold value, or until a maximum likelihood or goodness of fit is achieved.

The method may use a Bayesian approach.

The model may relate said spectral data to parameters representing: the abundance of ions for each charge state of one of said calibrant species; and/or the mass to charge ratio peak width for each charge state of said one of the calibrant species.

The method may comprise: arranging the data pairs as spectral data that represents the abundance of ions as a function of the second value related to charge state; and performing charge state peak locating on said spectral data by using a model that relates said spectral data to one or more parameters.

The one or more parameters may include parameters representing the values of the charge states of the ions, and/or a parameter that represents the peak width of each charge state.

The values of the charge states may be known, or unknown. If the charge state values are known then the known values may be included in the model accordingly. If different calibrant species are analysed then the range of known charge states may be different for the different calibrant species. Alternatively, if the charge states are unknown, the method may involve trialling different values for the charges state until the likelihood or goodness of fit is achieved that is above a threshold value, or until a maximum likelihood or goodness of fit is achieved.

The values of the charge states that provide this likelihood or goodness of fit may then be determined as being the charge states of the ions.

The model may also relates said spectral data to a parameter representing the mass of each charge carrier that gives rise to the charge state, such as the mass of a proton.

Each step of arranging the data pairs as spectral data may comprise selecting only a subset of the data pairs that have certain combinations of said first and second values, and arranging only these data pairs as the spectral data.

Said certain combinations of said first and second values may be selected so as to prevent ions that have substantially the same mass to charge ratio, but significantly different masses, from being considered to relate to the same ion peak.

Said certain combinations of said first and second values may be selected so as to include only ions of a single calibrant species, optionally where the ions have multiple different charge states.

The selection step may comprise selecting only data pairs that fall within a single zone, or within multiple discrete zones, of a two-dimensional map of the data pairs, where one dimension of the map is the first value related to mass to charge ratio and the other dimension of the map is said second value related to the charge of the ion.

Each of the zones may have a shape that is substantially a parallelogram, such as an elongated rectangle.

The method may comprise: performing said step of selecting only a subset of the data pairs multiple times so as to obtain multiple different subsets of data pairs that include ions of different respective calibrant species, so as to thereby obtain different sets of spectral data for the different respective calibrant species; providing a model for each set of spectral data that relates that spectral data to said parameters; specifying a function that provides a likelihood, or goodness of fit, of each model to its respective set of spectral data for a given set of values for said parameters; and for each set of spectral data, using its respective model and function to determine a set of values for said parameters that fit the model to the spectral data.

The step of arranging the data pairs as spectral data may comprise histogramming the data pairs onto an axis representing said first values such that the histogrammed data represents a spectrum of ion abundance as a function of the first value related to mass to charge ratio; and the model may relate said histogrammed data to said parameters.

The step of arranging the data pairs as spectral data may comprise arranging the data into a two-dimensional map having a first dimension representing the first value and a second dimension representing the second value; where the model further includes a parameter that represents the peak width, in the second dimension, of each charge state; and where the model relates said map of data to said parameters.

The present invention also provides a computer implemented method for performing the methods described above in relation to the second aspect of the present invention.

The present invention also provides a charge detection mass spectrometer configured to perform the methods described above in relation to the second aspect of the present invention.

As described in relation to the second aspect of the present invention, the present invention may perform mass to charge ratio peak locating, optionally along with charge state peak locating. More specifically, as described above, the peak locating may be performed in the context of a two-dimensional map having a first dimension representing the mass to charge ratio and a second dimension representing charge state. Alternatively, the mass to charge ratio peak locating may first be performed and then followed by charge state peak locating, or charge state peak locating may first be performed followed by mass to charge ratio peak locating. However, the charge state peak locating is inventive in its own right, as described below in relation to other aspects of the present invention.

A method of charge state calibration has been described in relation to the second aspect of the invention in which the data pairs are arranged as spectral data that represents the abundance of ions as a function of the second value related to charge state. However, it is contemplated herein that the charge state calibration may be performed without first arranging the data pairs in this manner.

Accordingly, from a third aspect of the invention there is provided a method of calibrating a charge detection mass spectrometer, comprising: analysing ions of one or more calibrant species using said charge detection mass spectrometer so as to obtain data related to the mass to charge ratios and charges of the ions; and a) determining charge state related peak positions for the ions by using a model that relates said data to one or more parameters; and/or b) inferring mass to charge ratio related peak positions for the ions by using a model that relates said data to one or more parameters.

This method may have any of the features described above in relation to the second aspect of the invention, except that the step of arranging the data pairs need not necessarily be performed.

For example, at least one of said one or more calibrant species may have ions of multiple different charge states that are analysed in said analysing step. Accordingly, each of said one or more calibrant species may have ions of multiple different charge states that are analysed in said analysing step.

Different charge state related peak positions may therefore be inferred for different respective charge states of each calibrant species.

For each of steps a) and b) above, the method may comprise: specifying a function that provides a likelihood, or goodness of fit, of the model to the data for a given set of values for said parameters; and using said model, said function and said data to determine a set of values for said parameters that fit the model to the data.

The step of using said model, said function and said data may comprise varying said set of values, e.g. iteratively, until a likelihood or goodness of fit is achieved that is above a threshold value, or until a maximum likelihood or goodness of fit is achieved.

The method may use a Bayesian approach.

The one or more parameters may include parameters representing the values of the charge states of the ions.

The values of the charge states may be known, or unknown. If the charge state values are known then the known values may be included in the model accordingly. If different calibrant species are analysed then the range of known charge states may be different for the different calibrant species. Alternatively, if the charge states are unknown, the method may involve trialling different values for the charges state until the likelihood or goodness of fit is achieved that is above a threshold value, or until a maximum likelihood or goodness of fit is achieved. The values of the charge states that provide this likelihood or goodness of fit may then be determined as being the charge states of the ions.

The present invention also provides a computer implemented method for performing the methods described above in relation to the third aspect of the present invention.

The present invention also provides a charge detection mass spectrometer configured to perform the methods described above in relation to the third aspect of the present invention.

From a fourth aspect of the invention there is provided a method of calibrating a charge detection mass spectrometer, comprising: analysing ions of one or more calibrant species using said charge detection mass spectrometer so as to obtain data representative of the charge states of the ions; and using a model that relates said data to calibration parameters that relate data obtained when analysing a given ion using said charge detection mass spectrometer to its charge state.

Said analysing ions may comprise causing each ion to oscillate in an ion trap, measuring the frequency at which the ion oscillates so as to obtain a signal, and measuring the magnitude of the signal so as to obtain said data representative of the charge state of the ion.

Said charge state may be equal to the sum of a first constant with the product of a second constant and said magnitude, wherein said calibration parameters are said first and second constants.

The method may comprise: specifying a function that provides a likelihood, or goodness of fit, of the model to the data for a given set of values for said parameters; and using said model, said function and said data to determine values of the calibration parameters, optionally together with a value for the uncertainty associated with these determined values of the calibration parameters.

The present invention also provides a computer implemented method for performing the methods described above in relation to the fourth aspect of the present invention.

The present invention also provides a charge detection mass spectrometer configured to perform the methods described above in relation to the fourth aspect of the present invention.

The concept of selecting only some of the data pairs for use in calibration is novel in its own right. Accordingly, from a fifth aspect the present invention provides a method of calibrating a charge detection mass spectrometer, comprising: analysing ions of one or more calibrant species using said charge detection mass spectrometer so as to obtain a data pair for each ion that is analysed, where the data pair comprises a first value related to the mass to charge ratio of the ion and a second value related to the charge of the ion; selecting only a subset of the data pairs that have certain combinations of said first and second values; arranging the subset of data pairs as spectral data that represents the abundance of ions as a function of the first value related to mass to charge ratio, and optionally also as a function of the second value related to charge state; and performing peak locating on said spectral data.

Said certain combinations of said first and second values may be pre-selected combinations. These combinations may be selected so as to prevent ions that have substantially the same mass to charge ratio, but significantly different masses, from being considered to relate to the same ion peak. This improves the accuracy of the calibration process.

The data pairs may be histogrammed onto a predetermined axis that is representative of the first value related to mass to charge ratio so as to represent a spectrum of ion abundance as a function of the first value. A peak locating process may then performed on the spectrum.

The fifth aspect of the present invention may have any of the optional features described in relation to the second aspect of the present invention.

For example, said certain combinations of said first and second values may be selected so as to include only ions of a single calibrant species, optionally where the ions have multiple different charge states.

The selection step may comprise selecting only data pairs that fall within a single zone, or within multiple discrete zones, of a two-dimensional map of the data pairs, where one dimension of the map is the first value representative of the mass to charge ratio and the other dimension of the map is said second value representative of the charge of the ion.

Each of the zones may have has a shape that is substantially a parallelogram, such as an elongated rectangle.

Said peak locating may locate one or more mass to charge ratio peaks for the ions; and the method may comprise performing charge-state calibration steps comprising: selecting only data pairs from said subset of data pairs that fall within a mass to charge ratio window that is arranged on each of said one of said one or more mass to charge ratio peaks; assigning a known or expected charge state to the data pairs that fall within any given window; and using the second values of the selected data pairs within a window, along with the assigned charge state for that window, to determine parameters that relate the second value of an ion to its charge state.

The step of selecting only data pairs that fall within a mass to charge ratio window may comprise selecting only data pairs, from said subset of data pairs, that fall within a mass to charge ratio window that is centred on the average or centroid mass to charge ratio value of the mass to charge ratio peak.

The width of the window may be smaller than the width of the mass to charge ratio peak. The step of using the second values to determine said parameters may comprise determining a consensus value for the second values, and using this consensus value along with the assigned charge state to determine said parameters; optionally wherein said parameters are determined from the relationship z=c₀+c₁A, where z is the assigned charge state, A is the consensus value, and c₀ and c₁ are said parameters and are constants.

The present invention also provides a computer implemented method and a mass spectrometer configured to perform the fifth aspect of the present invention.

The concept of selecting only some of the data pairs for inferring a charge state is novel in its own right. Accordingly, from a sixth aspect the present invention provides a method of calibrating a charge detection mass spectrometer, comprising: analysing ions of one or more calibrant species using said charge detection mass spectrometer so as to obtain a data pair for each ion that is analysed, where the data pair comprises a first value related to the mass to charge ratio of the ion and a second value related to the charge of the ion; locating one or more mass to charge ratio peaks for the ions; selecting only data pairs that fall within a mass to charge ratio window that is arranged on each one of said one or more mass to charge ratio peaks; and using the second values of these selected data pairs to perform charge state calibration of the spectrometer.

The step of selecting only data pairs that fall within a mass to charge ratio window may comprise selecting only data pairs that fall within a mass to charge ratio window that is centred on the average or centroid mass to charge ratio value of the mass to charge ratio peak.

The step of performing charge state calibration may comprise: assigning a known or expected charge state to the data pairs that fall within any given window; and using the second values of the selected data pairs within a window, along with the assigned charge state for that window, to determine parameters that relate the second value of an ion to its charge state.

The step of using the second values to determine said parameters may comprise determining a consensus value for the second values, and using this consensus value along with the assigned charge state to determine said parameters.

Said parameters may be determined from the relationship z=c₀+c₁A, where z is the assigned charge state, A is the consensus value, and c₀ and c₁ are said parameters and are constants.

The width of the window may be smaller than the width of the mass to charge ratio peak.

The present invention also provides a computer implemented method and a mass spectrometer configured to perform the sixth aspect of the present invention.

It is recognised herein that the additional mass parameters and the peak width/shape parameters are useful in identifying problems with the mass spectrometer and sample preparation. For example, insufficient sample clean up during sample preparation, problems with the ion generation, and insufficient desolvation or insufficient declustering of the ions in the spectrometer can all lead to an increase in the additional mass that is coupled to a calibrant ion and/or to a change in the peak width and/or peak shape detected for some or all of the calibrant species. Accordingly, the values of the additional mass parameters and/or peak width/shape parameters may be determined for some or all of the calibrant species and used to identify such problems.

Accordingly, from a seventh aspect the present invention provides a method of mass spectrometry comprising: analysing ions of one or more ion species using a charge detection mass spectrometer so as to obtain data representative of the mass to charge ratios of the ions; providing a model that relates said data to parameters including a known minimum mass of each ion species, and an additional mass that may be attached to an ion of each ion species during said analysing; specifying a function that provides a likelihood, or goodness of fit, of the model to the data for a given set of values for said parameters; using said model, said function and said data to calculate a value of the additional mass that fits said data; and determining if the calculated value of additional mass differs from a pre-selected value for the additional mass by more than a threshold amount, or falls outside of a preselected range of values for the additional mass.

The method may trial, e.g. iteratively, different values for the parameters until a likelihood or goodness of fit is achieved that is above a threshold value, or until a maximum likelihood or goodness of fit is achieved. The value of the additional mass that provides this likelihood or goodness of fit may then be determined as being the additional mass for the ions.

The ions may be ions of a calibrant species.

The parameters of the model may also include parameters representing: at least one charge state for ions of each ion species; and a calibration parameter that relates data obtained when analysing a given ion using said charge detection mass spectrometer to its mass to charge ratio.

When the calculated value differs from the pre-selected value by more than a threshold amount, or falls outside of the preselected range of values, then the spectrometer may trigger an output.

The output may be an alert, such as an alert that the spectrometer requires maintenance and/or a sample being analysed has not been prepared correctly.

The output may be a graphical output on an electronic display, or an audible output from a speaker.

The seventh aspect of the present invention also provides a method of mass spectrometry comprising: analysing ions of one or more ion species using a charge detection mass spectrometer so as to obtain a data pair for each ion that is detected, where the data pair comprises a first value related to the mass to charge ratio of the ion and a second value related to the charge of the ion; arranging the data pairs as spectral data that represents the abundance of ions as a function of the first value related to mass to charge ratio; and providing a model that relates said spectral data to a set of parameters that includes parameters representing the mass to charge ratio peak width and/or peak shape for each charge state of said one of the ion species; specifying a function that provides a likelihood, or goodness of fit, of the model to the spectral data for a given set of values for said parameters; using said model, said function and said spectral data to calculate the mass to charge ratio peak width and/or peak shape that fits the data; and determining if the calculated peak width and/or peak shape differs from a pre-selected peak width and/or peak shape.

The method may comprise determining if the calculated peak width and/or peak shape differs from a pre-selected peak width and/or peak shape by more than a threshold amount, or falls outside of a preselected range of values for the peak width and/or a preselected range of peak shapes.

The method may trial, e.g. iteratively, different values for the parameters until a likelihood or goodness of fit is achieved that is above a threshold value, or until a maximum likelihood or goodness of fit is achieved. The value of the peak width and/or peak shape that provides this likelihood or goodness of fit may then be determined as being the peak width and/or peak shape for the ions.

The ions may be ions of a calibrant species.

The parameters of the model may also include parameters representing: a known minimum mass for each ion of each ion species; an additional mass value representing a mass that may be attached to each ion during said analysing; and the abundance of ions for each charge state of one of said ion species.

When the calculated peak width and/or peak shape differs from a pre-selected peak width and/or peak shape by more than a threshold amount, or falls outside of a preselected range of values for the peak width and/or a preselected range of peak shapes, then the spectrometer may trigger an output.

The output may be an alert, such as an alert that the spectrometer requires maintenance and/or a sample being analysed has not been prepared correctly.

The output may be a graphical output on an electronic display, or an audible output from a speaker.

The present invention also provides a computer implemented method and a mass spectrometer configured to perform the seventh aspect of the present invention.

It has been found that it is particularly important to limit the number of calibrant ions in the analyser when obtaining the calibration data, in order to achieve an accurate calibration. More specifically, limiting the number of calibrant ions in the analyser prevents distortions arising from processing of congested data and/or reduces the likelihood of ion-ion interactions within the ion trap that would distort the measurements.

Accordingly, in any of the methods described above, said analysing ions may comprise admitting multiple ions into an ion trap, trapping these ions simultaneously and causing them to oscillate in the ion trap, and measuring the frequency at which each ion oscillates so as to obtain a value related to its mass to charge ratio; wherein ions travelling to said ion trap are attenuated by an ion attenuator so as to restrict the number of ions admitted into and simultaneously trapped in the ion trap. The attenuation may be performed so as to control the number of ions admitted into and simultaneously trapped in the ion trap based on a pre-selected target value for the number of ions desired to be admitted into and simultaneously trapped in the ion trap.

The spectrometer may perform multiple different trapping events during which the ion trap traps and analyses different respective ions, and the spectrometer may detect the number of ions trapped during one or more of the trapping events. The spectrometer may then: (i) control the level of attenuation that the ion attenuator performs in response to the detected number of ions, and based on a pre-selected target value for the number of ions desired to be admitted into and simultaneously trapped in the ion trap, so as to control the number of ions admitted into and simultaneously trapped in the ion trap in a subsequent trapping event; and/or (ii) control the duration of time during which the ion trap admits ions in response to the detected number of ions, and based on a pre-selected target value for the number of ions desired to be admitted into and simultaneously trapped in the ion trap, so as to control the number of ions admitted into and simultaneously trapped in the ion trap in a subsequent trapping event. Method steps (i) and/or (ii) are preferably performed so that the number of ions admitted into and simultaneously trapped in the ion trap in the subsequent trapping event is below the pre-selected target value.

These methods are novel in their own right. Accordingly, from an eighth aspect the present invention provides a method of mass spectrometry comprising: analysing ions of one or more calibrant ion species using a charge detection mass spectrometer by admitting multiple ions into an ion trap, trapping these ions simultaneously and causing them to oscillate in the ion trap, and measuring the frequency at which each ion oscillates so as to obtain a value related to its mass to charge ratio; wherein ions travelling to said ion trap are attenuated by an ion attenuator so as to restrict the number of ions admitted into and simultaneously trapped in the ion trap.

The attenuation may be performed so as to control the number of ions admitted into and simultaneously trapped in the ion trap based on a pre-selected target value for the number of ions desired to be admitted into and simultaneously trapped in the ion trap.

The spectrometer may perform multiple different trapping events during which the ion trap traps and analyses different respective ions, wherein the spectrometer detects the number of ions trapped during one or more of the trapping events; and (i) wherein the spectrometer controls the level of attenuation that the ion attenuator performs in response to the detected number of ions, and based on a pre-selected target value for the number of ions desired to be admitted into and simultaneously trapped in the ion trap, so as to control the number of ions admitted into and simultaneously trapped in the ion trap in a subsequent trapping event; and/or (ii) wherein the spectrometer controls the duration of time during which the ion trap admits ions in response to the detected number of ions, and based on a pre-selected target value for the number of ions desired to be admitted into and simultaneously trapped in the ion trap, so as to control the number of ions admitted into and simultaneously trapped in the ion trap in a subsequent trapping event.

Method steps (i) and/or (ii) are preferably performed so that the number of ions admitted into and simultaneously trapped in the ion trap in the subsequent trapping event is below the pre-selected target value.

The present invention also provides a computer implemented method and a mass spectrometer configured to perform the eighth aspect of the present invention.

Although embodiments have been described above for calibrating a charge detection mass spectrometer, the techniques described herein may alternatively be used for calibrating other types of mass spectrometer. For example, the techniques described herein may be used for mass to charge ratio calibration in a quadrupole, Time of Flight or Orbitrap mass spectrometer.

Accordingly, the first aspect the present invention also provides a method of calibrating a mass spectrometer, comprising: analysing ions of one or more calibrant species using said mass spectrometer so as to obtain data representative of the mass to charge ratios of the ions, where a minimum mass is known for an ion of each calibrant species; and using said data, said minimum mass, and an additional mass value representing a mass that may be attached to each of the one or more calibrant species during said analysing to determine a calibration parameter that relates data obtained when analysing a given ion species using said mass spectrometer to its mass to charge ratio.

The second aspect the present invention also provides a method of calibrating a mass spectrometer, comprising: analysing ions of one or more calibrant species using said mass spectrometer so as to obtain data for each ion that is detected, where the data comprises a first value related to the mass to charge ratio of the ion; arranging the data as spectral data that represents the abundance of ions as a function of the first value related to mass to charge ratio; and performing peak locating on said spectral data by using a model that relates said spectral data to a set of parameters that, optionally, includes one or more parameters that represent the mass for each ion of each calibrant species and a parameter that relates a first value measured by the spectrometer to a mass to charge ratio.

The third aspect the present invention also provides a method of calibrating a mass spectrometer, comprising: analysing ions of one or more calibrant species using said mass spectrometer so as to obtain data related to the mass to charge ratios and charges of the ions; and a) determining charge state related peak positions for the ions by using a model that relates said data to one or more parameters; and/or b) inferring mass to charge ratio related peak positions for the ions by using a model that relates said data to one or more parameters.

The fourth aspect the present invention also provides a method of calibrating a mass spectrometer, comprising: analysing ions of one or more calibrant species using said mass spectrometer so as to obtain data representative of the charge states of the ions; and using a model that relates said data to calibration parameters that relate data obtained when analysing a given ion using said mass spectrometer to its charge state.

The fifth aspect the present invention also provides a method of calibrating a mass spectrometer, comprising: analysing ions of one or more calibrant species using said spectrometer so as to obtain a data pair for each ion that is analysed, where the data pair comprises a first value related to the mass to charge ratio of the ion and a second value related to another physicochemical property, such as mobility; selecting only a subset of the data pairs that have certain combinations of said first and second values; arranging the subset of data pairs as spectral data that represents the abundance of ions as a function of the first value related to mass to charge ratio, and optionally also as a function of the second value; and performing peak locating on said spectral data.

The sixth aspect the present invention provides a method of calibrating a mass spectrometer, comprising: analysing ions of one or more calibrant species using said mass spectrometer so as to obtain a data pair for each ion that is analysed, where the data pair comprises a first value related to the mass to charge ratio of the ion and a second value related to the charge of the ion; locating one or more mass to charge ratio peaks for the ions; selecting only data pairs that fall within a mass to charge ratio window that is arranged on each one of said one or more mass to charge ratio peaks; and using the second values of these selected data pairs to perform charge state calibration of the spectrometer.

The seventh aspect the present invention provides a method of mass spectrometry comprising: analysing ions of one or more ion species using a mass spectrometer so as to obtain data representative of the mass to charge ratios of the ions; providing a model that relates said data to parameters including a known minimum mass of each ion species, and an additional mass that may be attached to an ion of each ion species during said analysing; specifying a function that provides a likelihood, or goodness of fit, of the model to the data for a given set of values for said parameters; using said model, said function and said data to calculate a value of the additional mass that fits said data; and determining if the calculated value of additional mass differs from a pre-selected value for the additional mass by more than a threshold amount, or falls outside of a preselected range of values for the additional mass.

The seventh aspect of the present invention also provides a method of mass spectrometry comprising: analysing ions of one or more ion species using a mass spectrometer so as to obtain data representative of the mass to charge ratios of the ions; arranging the data as spectral data that represents the abundance of ions as a function of mass to charge ratio; and providing a model that relates said spectral data to a set of parameters that includes parameters representing the mass to charge ratio peak width and/or peak shape said one of the ion species; specifying a function that provides a likelihood, or goodness of fit, of the model to the spectral data for a given set of values for said parameters; using said model, said function and said spectral data to calculate the mass to charge ratio peak width and/or peak shape that fits the data; and determining if the calculated peak width and/or peak shape differs from a pre-selected peak width and/or peak shape.

The eighth aspect of the present invention also provides a method of mass spectrometry comprising: analysing ions of one or more calibrant ion species using a mass spectrometer by admitting multiple ions into an ion trap, trapping these ions simultaneously and causing them to oscillate in the ion trap, and measuring the frequency at which each ion oscillates so as to obtain a value related to its mass to charge ratio; wherein ions travelling to said ion trap are attenuated by an ion attenuator so as to restrict the number of ions admitted into and simultaneously trapped in the ion trap.

The spectrometer may perform multiple different trapping events during which the ion trap traps and analyses different respective ions. The spectrometer may detect the number of ions trapped during one or more of the trapping events, and the spectrometer may control: (i) the level of attenuation that the ion attenuator performs in response to the detected number of ions, and based on a pre-selected target value for the number of ions desired to be admitted into and simultaneously trapped in the ion trap, so as to control the number of ions admitted into and simultaneously trapped in the ion trap in a subsequent trapping event; and/or (ii) the duration of time during which the ion trap admits ions in response to the detected number of ions, and based on a pre-selected target value for the number of ions desired to be admitted into and simultaneously trapped in the ion trap, so as to control the number of ions admitted into and simultaneously trapped in the ion trap in a subsequent trapping event.

Various methods are described herein for performing mass to charge ratio and/or charge calibration of a spectrometer. The present invention also extends to using the obtained calibration relationship(s) to determine the mass to charge ratios and/or charges of other ions that are analysed. Accordingly, the present invention may comprise analysing at least one ion of one or more further ion species in the spectrometer so as to obtain data representative of the mass to charge ratio and/or charge state of the at least one ion; and determining the mass to charge ratio and/or charge state of said at least one ion using the calibration relationship(s).

### BRIEF DESCRIPTION OF THE DRAWINGS

Various embodiments of the present invention will now be described, by way of example only, and with reference to the accompanying drawings in which:

FIG. 1 shows a schematic of a portion of a charge detection mass spectrometer according to an embodiment of the present invention;

FIGS. 2A-2B show an example of the data that may be obtained by the mass spectrometer of FIG. 1;

FIGS. 3A-3C show data obtained by analysing three different calibrant species;

FIG. 4. illustrates a calibration relationship obtained from the data in FIGS. 3A-3C;

FIG. 5 shows the residual mass to charge ratio value for the data points in FIG. 4;

FIG. 6 shows a joint probability distribution plotted as a function of g, which has been determined according to an embodiment of the present invention; and

FIG. 7 shows a schematic of a schematic of a spectrometer according to an embodiment of the present invention.

### DETAILED DESCRIPTION

Charge Detection Mass Spectrometry (CDMS) has the potential to significantly extend the utility of mass spectrometry, e.g. for the analysis of relatively high molecular weight and highly heterogeneous samples. This is possible because CDMS involves the simultaneous measurement of the mass-to-charge ratio (m/z) and charge state (z) of an ion, which allows its mass (m) to be determined. The mass spectrometer is able to obtain relatively simple spectral data, since the spectral data may include peaks for the masses of the ions, rather than their mass to charge ratios, and so need not include multiple peaks for multiple respective charge states of the same ion species.

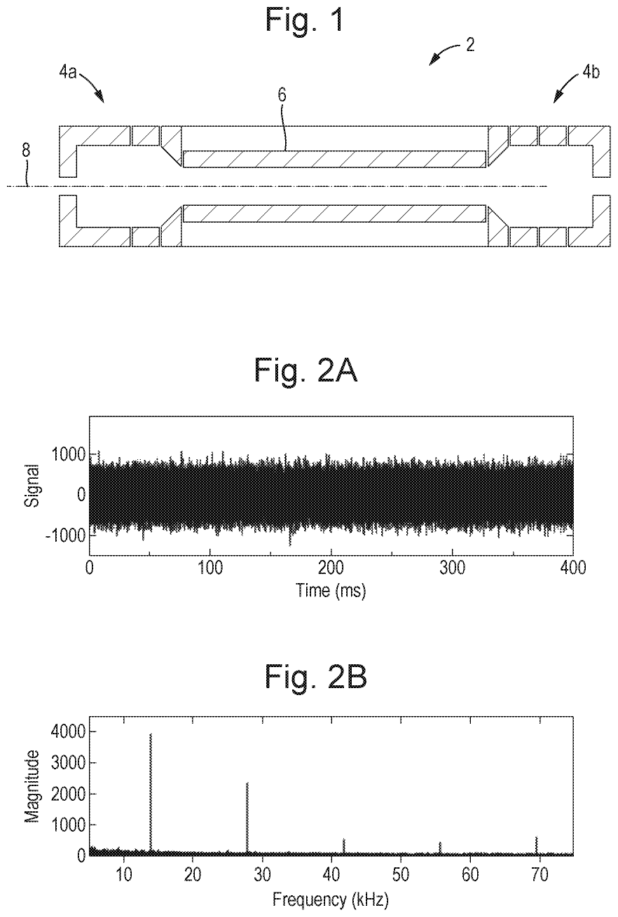

FIG. 1 shows a schematic of a portion of a charge detection mass spectrometer according to an embodiment of the present invention, which includes a charge detection mass analyser for performing CDMS. The analyser comprises an electrostatic ion trap 2 having two ion mirrors 4a,4b, which are also known as reflectrons, and an inductive detector 6 arranged therebetween. The ion trap 2 is elongated in a direction that extends between the ion mirrors 4a,4b and one or more ions are received in the ion trap along a central axis that is parallel to this direction, as illustrated by the dashed line 8. During operation of the mass analyser, one or more ions are supplied towards the ion trap 2 along the central axis 8 towards a first of the ion mirrors 4a. At this time the electrodes of the first ion mirror 4a are maintained at potentials such that the one or more ions are permitted to pass into the ion trap 2 through the first ion mirror. The voltages that are applied to the electrodes of both ion mirrors 4a,4b are then maintained at values so that the one or more ions are reflected back and forth between the ion mirrors, passing the inductive detector 6 each time that they do so. In the depicted embodiment the inductive detector 6 is a cylindrical tube through which the ions pass as they are reflected back and forth between the ion mirrors, although the detector need not be a tube and may take other forms (e.g. the analyser may be an Orbitrap). The ion mirrors cause each of the one or more ions to oscillate between the ion mirrors in a periodic manner and to induce an electrical charge on the inductive detector each time that it passes it. The inductive detector is connected to an acquisition system that measures the charge induced on the inductive detector as a function of time, processes this signal so as to determine the mass to charge ratio and charge state of each of the one or more ions, and then determines the mass of the ion by multiplying the measured mass to charge ratio by the measured charge state, e.g. as will be described with reference to FIGS. 2A-2B.

FIGS. 2A-2B show an example of the data that may be obtained by the mass analyser when it is analysing an ion species trapped in the ion trap 2. FIG. 2A shows the magnitude of the signal induced on the inductive detector 6 as a function of time when analysing the ions. This time-domain data is then converted into the frequency domain, e.g. by using a Fourier Transform or other method, so as to obtain the data shown in FIG. 2B, which therefore illustrates the magnitude of the signal as a function of frequency. As the signal generated by a single ion is not sinusoidal, but is approximately a square wave, its Fourier Transform contains harmonics. These harmonics occur at a fundamental frequency F, which is the frequency at which the ion oscillates in the trap, and at multiples thereof, i.e. at 2F, 3F etc.

As will be appreciated, the frequency F with which an ion oscillates in the ion trap 2 is related to its mass to charge ratio, and the charge of the ion is proportional to the magnitude or amplitude of the portion of the signal corresponding to that ion. Referring to the example shown in FIG. 2B, it can be seen that there are five distinct peaks at five different frequencies. A first peak at approximately 14 kHz is the fundamental frequency F at which the ion oscillates in the ion trap, whereas the remaining four peaks are harmonics occurring at integer multiples of the fundamental frequency. It will be appreciated that the mass to charge ratio of the ion can be determined from the frequency value of the peak that represents the fundamental frequency F. The charge of the ion can be determined from the amplitude of this peak. However, it is contemplated herein that other methods of determining the amplitude are possible, such as forward fitting of the time domain data, or methods that combine harmonics (e.g. by adding their amplitudes).

More specifically, the mass to charge ratio of an ion is generally assumed to be proportional to (or linearly related to) the inverse of the square of its oscillation frequency within the ion trap. Accordingly, the mass to charge ratio (m/z) of an ion is given by m/z=k/F², where k is a constant and F is the frequency with which the ion oscillates in the ion trap. It is generally assumed that the charge of the ion is linearly related to the magnitude or amplitude of the portion of the signal corresponding to that ion. Accordingly, the charge (z) of an ion may be represented by z=c₀+c₁A, where c₀ and c₁ are constants and A is the magnitude or amplitude of the portion of the signal corresponding to that ion. In order to determine the mass to charge ratio and charge of an ion it is therefore necessary to determine the constants k, c₀ and c₁. Conventionally these constants are obtained by analysing calibrant species that have known theoretical mass values and known charge states.

However, an unusual aspect of CDMS calibration is that, owing to their size, the ions of the calibrant species used to calibrate the CDMS mass analyser can carry a relatively large mass in addition to the mass of the calibrant species itself. For example, the calibrant species may be a protein or peptide and the calibrant species may carry residual solvent or one or more adducts such as salts. As each calibrant species used typically has a relatively high mass, it is likely to carry a significant additional mass in the gas phase. As such, the additional mass causes errors to be introduced into the calibration procedure. Furthermore, this additional mass may vary depending on a number of factors, such as it varying between different experimental runs, varying between different sample preparations, varying between different electrospray conditions, varying between different conditions inside the mass spectrometer, or varying depending on the origin of the sample. The actual mass associated with the calibrant species that is being analysed is therefore different to the mass value that is predicted based on the theoretical composition of the calibrant species, e.g. based on its DNA/RNA sequence or amino acid sequence. This leads to uncertainly in the calibration of the mass to charge ratio scale, and can also indirectly lead to uncertainty in the calibration of the charge state scale.

Furthermore, it is generally beneficial to perform the above-mentioned calibration using multiple different calibrant species having different respective masses, so as to cover a wider range of charge states and mass to charge ratio values than would be possible using only a single calibrant species. However, each of these different calibrant species will typically have a different proportion of additional mass, depending on its physicochemical characteristics, its preparation, and other factors. This variability leads to systematic differences between mass to charge ratio calibration residuals for different calibrant species, resulting in calibrations with compromised precision as well as accuracy.

As the aim of calibration is to relate an observed ion signal to a true mass to charge ratio and to a true charge, uncertainties in the true mass to charge ratio and charge lead to unwanted uncertainty in the calibration and, therefore, to uncertainty in the inferred masses for measured ion signals. Embodiments of the present invention provide methods of calibration which minimise the effect of the additional mass associated with each calibrant species, while also acknowledging that it exists and properly quantifying the resulting uncertainty in mass to charge ratio, charge and ultimately the mass measurement.

Embodiments of the present invention provide a calibration procedure that can simultaneously accommodate data corresponding to multiple calibrant species, each of which has a theoretical (or, more generally, lower bound) mass and an unknown amount of additional mass, so as to yield a calibration with high precision and accuracy along with well-defined uncertainties.

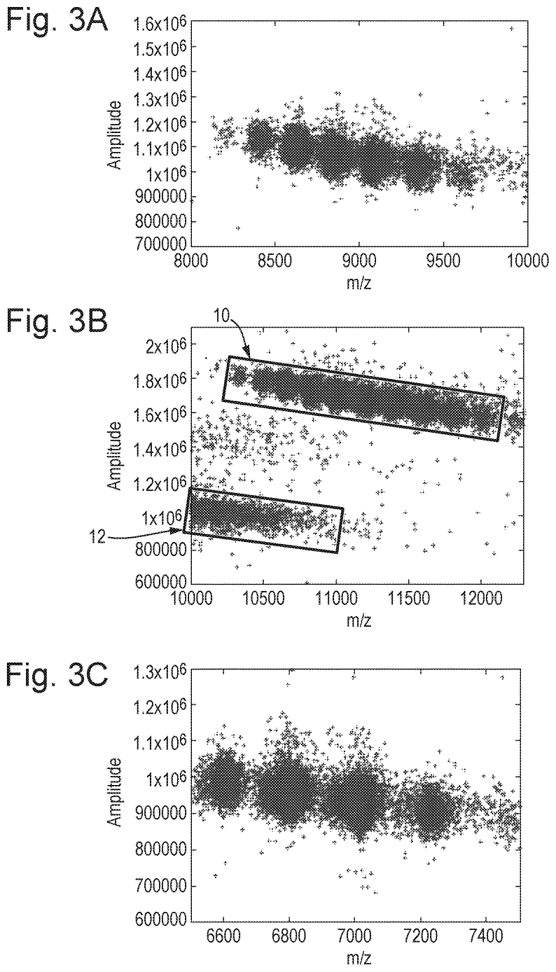

The technique may begin by analysing multiple different calibrant species using CDMS. The analysis may be performed on many ions of each calibrant species and the frequency of oscillation for each ion may be measured in the manner described above, as well as the amplitude of each respective peak. As described above, the frequency is related to the mass to charge ratio of the ion, whereas the amplitude is related to the charge state of the ion. Different ions of each calibrant species may have different charge states, and hence different mass to charge ratios and frequencies of oscillation, e.g. as shown by way of example with reference to FIGS. 3A-3C.

FIGS. 3A-3C show data obtained by analysing three different calibrant species by CDMS, where each data point represents the measurements for a single ion. Each data point therefore represents the mass to charge ratio of the ion (x-axis) that has been determined from its frequency of oscillation, and the charge of the ion (y-axis) that has been determined from the amplitude of the frequency peak. FIG. 3A shows data obtained when analysing glutamate dehydrogenase (GDH) monomer (hexamer). This calibrant species is known to have a mass of approximately 330 kDa and has ions with charge states around 38+. FIG. 3B shows data obtained when analysing GDH dimer (dodecamer). This calibrant species is known to have a mass of approximately 660 kDa and has charges states around 60+. The box 10 includes data corresponding to the dodecamer, whereas box 12 includes the data corresponding to the monomer tail. FIG. 3C shows data obtained when analysing pyruvate kinase tetramer. This calibrant species is known to have a mass of approximately 230 kDa and has charge states around 34+.

It will be appreciated that the calibrant species of FIGS. 3A-3C are exemplary and that other calibrant species, and/or a different number of different calibrant species may be used. The data for all of the calibrant species may be acquired in a single experiment, if the calibrant species can be combined into a single mixture and the data from the calibrant species do not overlay each other in frequency and magnitude. Alternatively, multiple experiments may be performed, each corresponding to a sample containing one or more calibrant species that do not produce ions that overlap in frequency and magnitude.

Each calibrant species will typically be represented in the raw data by multiple charge states, as can be seen in FIGS. 3A-3C by the data points being clustered around certain mass to charge ratio values. The dataset corresponding to each calibrant species may be processed to locate peaks corresponding to individual charge states of the calibrant species and to assign consensus frequency and magnitude/amplitude values to each charge state peak, as will be described further below.

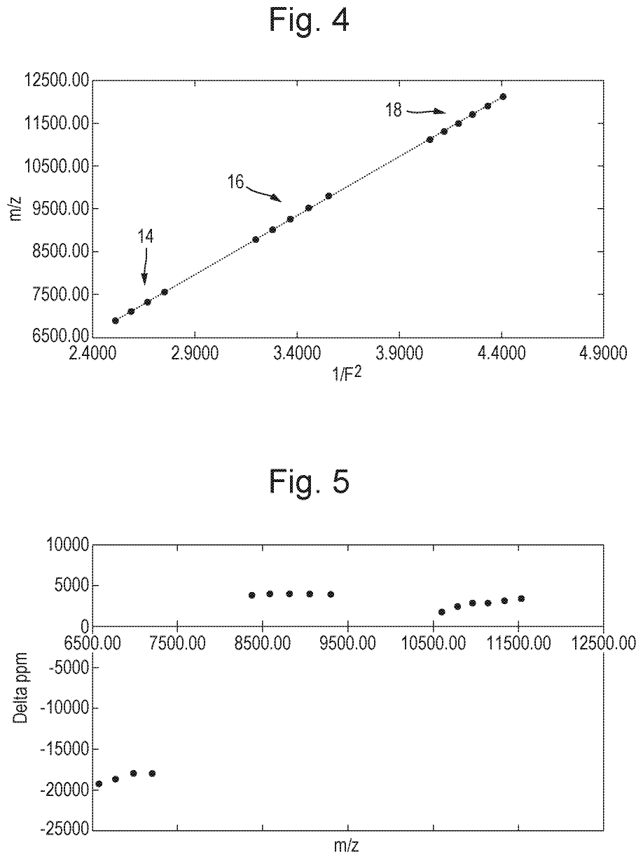

According to conventional techniques, the theoretical mass to charge ratio for each of these peaks is determined from the theoretical mass of its respective calibrant species divided by its charge state. As such, it is conventional to determine a calibration relationship that relates the determined consensus frequencies to the theoretical mass to charge ratio values, as shown in FIG. 4.

FIG. 4. illustrates a calibration relationship that relates the determined consensus frequencies for the calibrant species in FIGS. 3A-3C to their theoretical mass to charge ratio values. More specifically, the y-axis represents the theoretical mass to charge ratio of the calibrant species and the x-axis represents the inverse of the square of the oscillation frequency of the ion species, which is proportional to its mass to charge ratio. Data points 14 represent the data points for the different charge states of the pyruvate kinase tetramer, data points 16 represent the data points for the different charge states of the GDH monomer, and data points 18 represent the data points for the different charge states of the GDH dimer. As the mass to charge ratio of an ion is considered to be given by m/z=k/F², a linear calibration relationship is fitted to the data points, and the gradient of the linear calibration relationship is determined as the coefficient k. When an ion of unknown mass to charge ratio is analysed its oscillation frequency is measured and can be used, along with the calibration relationship, to determine its mass to charge ratio.

FIG. 5 shows the residual mass to charge ratio value for the data points in FIG. 4. More specifically, each data point in FIG. 4 is assigned a residual mass to charge ratio value as the vertical distance between that data point and the calibration relationship. It can be seen from FIG. 5 that some of the residual mass to charge ratio values are relatively high, indicating that the calibration relationship is not particularly accurate over at least some of the mass to charge ratios. This is, in part, due to the problems discussed above, i.e. that the calibrant species include unknown additional masses.

In contrast to such conventional techniques for determining calibration relationships, embodiments of the present invention specify a mathematical model which relates the data measured by the CDMS analyser to the known theoretical mass of each calibrant species, its known one or more charge states, and the additional mass associated with that calibrant species. It may, or may not, be assumed that different charge states of the same calibrant species will have the same additional mass. The unknown parameters in this mathematical model are the additional mass for each calibrant species and the constant k described above, i.e. the constant of proportionality between mass to charge ratio and the inverse of the square of ion oscillation frequency.

Prior probability distributions may be supplied for each unknown parameter, but at the very least it is known that the additional mass parameters for the calibrant species are positive values. A function is specified that provides a likelihood, or goodness of fit, of the model to the measured data for a given set of values of the parameters used in the model. This function, the model and the data are used to generate an inferred value for the parameter k together with an associated uncertainty. Optionally, inferred values of the additional mass parameters may also be calculated.

Assuming that prior probability distributions are specified for the unknown parameters, the inferred value for k may be an average or maximum a posteriori (MAP) of the Bayesian posterior probability distribution for k given the data. The additional mass parameters may be treated as nuisance parameters and marginalised out of the posterior distribution, either numerically or analytically. An average value of k and associated uncertainty may be obtained through Markov Chain Monte Carlo exploration of the posterior probability distribution. Alternatively the inferred value for k may be a least squares or maximum likelihood value.

This procedure has been applied to various combinations of potential calibrant species, yielding mass to charge ratio calibrations having precisions better than 0.1% and a charge precision of significantly less than unit charge for a 100 ms trapping time in the ion trap of the CDMS analyser.

A specific embodiment of the present invention will now be described in order to assist in the understanding of the present invention. According to this embodiment, a provisional mass to charge ratio calibration is specified as follows:

$$\frac{m}{z} = \frac{{k}_{0}}{{F}^{2}}$$

where k₀ is a provisional mass to charge ratio calibration parameter and F is the frequency of oscillation of an ion in the ion trap of the CDMS analyser. In contrast, the final calibration will be given by:

$$\frac{m}{z} = \frac{{k}_{0}}{{gF}^{2}}$$

where g is a calibration correction that is to be determined. It will be appreciated that alternatively the parameter k could equivalently be calibrated directly. However, providing a provisional mass to charge ratio calibration using ko allows measured ion frequencies to be immediately translated into provisional mass to charge ratio measurements, thus facilitating their comparison with theoretical mass to charge ratio values for each charge state of each calibrant species. The provisional calibration ko may be based on, for example, the physics of an ideal theoretic ion trap having exact voltages. Alternatively, the provisional calibration may be a value obtained previously for the ion trap that is to be calibrated, or it may be a value obtained for another calibrated ion trap of the same or similar design. Alternatively, the provisional calibration may be estimated.

In the model, it is assumed that the measured mass to charge ratio data for the calibrant species dᵢⱼ±σᵢⱼ have been provided for a number i=1 . . . N of different calibrant species having a range of known charge states zᵢⱼ, where i indexes the calibrant species, j indexes the charge state, and σᵢⱼ are uncertainties associated with the mass to charge ratio measurements for the N different calibrant species (e.g. the measurement precision). For example, the charge states for the first calibrant species (i.e. i=1) are zᵢⱼ=z₁₁, z₁₂, . . . , etc. The range of charge states provided in the model may be, and will generally be, different for each calibrant species. Also the chosen charge states for a given calibrant species need not be consecutive, e.g. a charge state may be omitted from a group of otherwise sequential charge states if it is subject to an chemical or electronic interference. The data dᵢⱼ are provided as mass to charge ratio values obtained from the respective ion oscillation frequencies using the provisional calibration k₀. Each of these may be an average of mass to charge ratio measurements of individual ions that have been identified as belonging to the calibrant species in question, or they may be obtained via a peak detection, peak locating or deconvolution method.

The model is also provided with the minimum mass for each of the calibrant species, which may be the theoretical mass value for the calibrant species. For example, if the calibrant species is a protein then the minimal mass may be the sequence mass for the protein. The model is therefore provided with a list of minimal masses mᵢ, i=1 . . . . N for the calibrant species. The model is also provided with an estimate of the scale of additional mass A; that is expected for each calibrant species. These scale parameters may be based on the size or type of the calibrant species, or may be based on measurements taken on other calibrated instruments, such as a time-of-flight mass spectrometer. As described above, calibrant species may have some unknown additional mass, e.g. due to solvent molecules or other adducts on the calibrant species. The model therefore assumes that each calibrant species has some unknown additional mass δᵢ, which may be the same for each of the charge states of a given calibrant species.

With these assumptions and definitions, the acquired mass to charge ratio calibration data dᵢⱼ can be described symbolically as:

$${d}_{i j} ≃ g \frac{{m}_{i} + {δ}_{i}}{{z}_{i j}} \pm {σ}_{i j}$$

It is to be noted that this ignores the contribution to mass of the charge carriers. This is generally a good approximation for analytes and calibrants used in CDMS experiments, although this mass contribution can be explicitly included in the analysis where necessary.

The unknown parameters in the above expression are the calibration parameter g and the N additional mass parameters δᵢ. In this embodiment a Bayesian approach is adopted to determine the parameter g, together with associated uncertainty, although it will be appreciated that other techniques could be used instead. For example, a maximum likelihood or least-squares approach could be used to determine the parameter g.

Prior probability distributions are specified for the unknowns parameters g and δᵢ, which represent the initial state of knowledge for these parameters, i.e. before analysing the calibration data. With regard to the calibration parameter g, this is expected to be somewhat close to a value of 1 because g=1 corresponds to an exactly correct provisional calibration k₀. For brevity and simplicity, in this embodiment an “improper” uniform prior for g is used, although it will be appreciated that any suitable prior having a mean of g=I could be used instead, such as a Cauchy or Gaussian.

With regard to δᵢ, we know that the values of these parameters are positive since they represent additional masses, and so the prior may reflect this. For example, one suitable choice for the prior is:

$$P r ( {δ}_{i} ) = \frac{1}{{Λ}_{i}} {e}^{- {δ}_{i} / {Λ}_{i}}$$

Assuming that the measurement errors are Gaussian, the joint probability distribution for the data and the parameters may be expressed as follows:

$$P r ( d , δ , g ) = {\prod }_{i = 1}^{N} \frac{1}{{Λ}_{i}} {e}^{- {δ}_{i} / {Λ}_{i}} {\prod }_{j ∈ {z}_{i}} \frac{1}{\sqrt{2 π} {σ}_{i j}} exp ( - \frac{{( {d}_{i j} - g \frac{{m}_{i} + {δ}_{i}}{{z}_{i j}} )}^{2}}{2 {σ}_{i j}^{2}} )$$

where the product over charge states runs over all charge states belonging to the i'th calibrant (j∈zᵢ). To facilitate further analysis, this can be rewritten as follows:

$$P r ( d , δ , g ) = \frac{1}{{( 2 π )}^{N / 2}} {\prod }_{i j} \frac{1}{{σ}_{i j}} {\prod }_{i = 1}^{N} \frac{1}{{Λ}_{i}} exp ( - \frac{{( {δ}_{i} - {δ}_{i 0} )}^{2}}{2 {S}_{i}^{2}} ) exp ( {\sum }_{i = 1}^{N} ( \frac{{B}_{i}^{2}}{4 {A}_{i}} - {C}_{i} ) )$$

where the first product runs over all data points, and where the new symbols are defined as follows:

$${A}_{i} = \frac{1}{2} {g}^{2} {X}_{i} , {B}_{i} = {g}^{2} {m}_{i} {X}_{i} - {gY}_{i} + \frac{1}{{Λ}_{i}} , {C}_{i} = \frac{1}{2} {g}^{2} {m}_{i}^{2} {X}_{i} - {gm}_{i} {Y}_{i} + \frac{1}{2} {Z}_{i}$$

$$and$$

$${S}_{i} = \frac{1}{\sqrt{2 {A}_{i}}} , {δ}_{i 0} = \frac{- {B}_{i}}{2 {A}_{i}} , {X}_{i} = {\sum }_{j ∈ {z}_{i}} \frac{1}{{z}_{j}^{2} {σ}_{i j}^{2}} , {Y}_{i} = {\sum }_{j ∈ {z}_{i}} \frac{{d}_{i j}}{{z}_{j} {σ}_{i j}^{2}} and$$

$${Z}_{i} = {\sum }_{j ∈ {z}_{i}} \frac{{d}_{i j}^{2}}{{σ}_{i j}^{2}} ,$$

The excess mass parameters δᵢ may not be of interest and so they may be removed from the joint probability by integrating over them using the well-known process of marginalisation, thereby providing a joint probability for the data and the calibration parameter g as follows:

$$P r ( d , g ) = \int \int {\int }_{0}^{∞} P r ( d , δ , g ) d {δ}_{1} d {δ}_{2} … d {δ}_{N}$$

where there are N integrals in total. This effectively means that all possible values for these parameters will be taken into account in the inferences that are made about the calibration parameter g. This integral can be performed exactly and analytically so as to obtain the following relationship:

$$P r ( d , g ) ∝ exp ( {\sum }_{i = 1}^{N} ( \frac{{B}_{i}^{2}}{4 {A}_{i}} - {C}_{i} ) ) {\prod }_{i = 1}^{N} {S}_{i} ( 1 + erf \frac{{δ}_{i 0}}{\sqrt{2} {S}_{i}} )$$

where erf is the error function, and where overall constant factors (which are independent of g) have been omitted for clarity.

The expression for Pr(d,g) as derived above depends only on g. Everything else, including the data, uncertainties and hyperparameters Λᵢ, is a known numerical quantity at the time of calibration. Any suitable method can be used to extract inferences about g from this distribution. It is often useful to numerically calculate the “evidence”:

$$P r ( d ) = {\int }_{0}^{∞} P r ( d , g ) dg$$

allowing us to calculate the properly normalised posterior probability distribution for g as:

$$P r ( g \vert d ) = \frac{P r ( d , g )}{P r ( d )}$$

as well as being an important tool for model comparison, e.g. comparing different possible charge state assignments.

There are several options for making inferences about g using the posterior probability distribution Pr(d,g). These options fall into two main categories, as follows. A first of the categories is to use the joint probability Pr(d,g) directly to numerically calculate a representative inferred value for g, such as a mean or maximum a posteriori value, together with a measure of uncertainty, such as standard deviation, confidence interval, or interquartile range. This will often involve calculating the evidence Pr(d). A second of the categories is to sample values of g from the joint probability distribution Pr(d,g), optionally also calculating the evidence Pr(d). Suitable techniques include a wide variety of Markov Chain Monte Carlo methods and nested sampling.

A simulation of the above approach was performed based on three calibrant species having theoretical, i.e. minimum, masses of m₁=230 kDa, m₂=330 kDa, and m₃=660 kDa. Additional masses values were sampled from exponential distributions with a mean of 1% additional mass so as to give “true” values of additional mass for the three calibrant species as δ₁=2118 Da, δ₂=1991 Da, and δ₃=20273 Da, respectively.

Simulated mass to charge ratio values were obtained for the following positive charge states of the calibrant species:

$${z}_{1 j} = 20 , 21 , 22 , 23 , 24$$

$${z}_{2 j} = 40 , 41 , 42 , 43 , 44 , 45$$

$${z}_{3 j} = 60 , 61 , 62 , 63$$

and by obtaining samples from Gaussian distributions having means of g(mᵢ+δᵢ)/zᵢⱼ and standard deviations of 100 parts per million. The “true” value of g in the simulation was taken to be g=1.10.

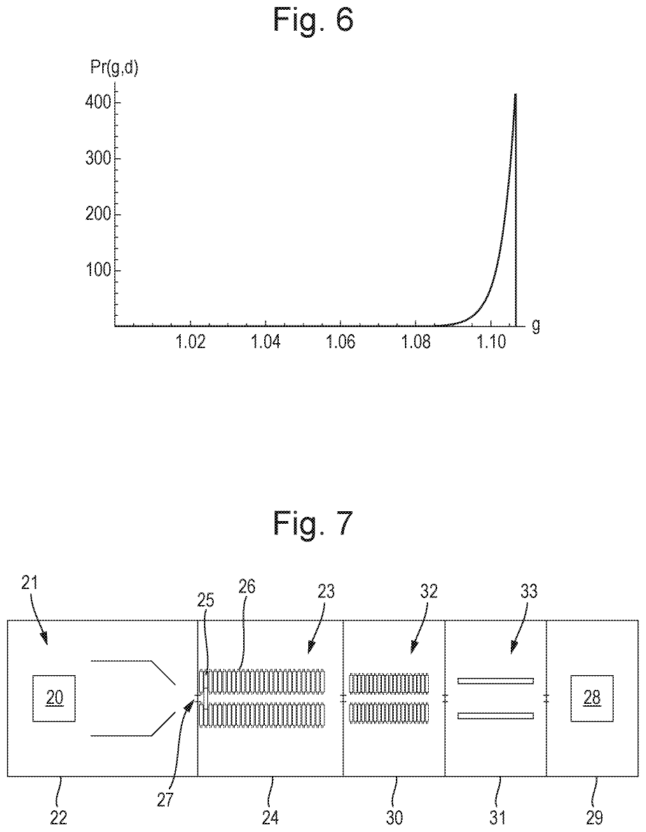

FIG. 6 shows the joint probability distribution plotted as a function of g. The inferred mean and standard deviation for the gain g are g=1.103±0.004, with the true value of g=1.10 lying comfortably within the inferred uncertainty. It can be seen that the value of the joint probability distribution suddenly drops to zero on the right of the plot. This is because the additional mass values must be positive values.

As has been described above, when seeking to obtain a calibration relationship, the mass analyser analyses ions of one or more calibrant species so as to obtain raw data, e.g. as described with reference to FIGS. 3A-3C. It is preferred that ions having multiple different charge states for each calibrant species are analysed. The mass analyser analyses the signal induced on its detector by the ions so as to obtain a measurement of the frequency at which each ion oscillates in the ion trap, which is related to the mass to charge ratio of the ion, and a magnitude of the signal corresponding to that frequency, which is related to the charge of the ion.

As part of the process of obtaining a mass to charge ratio calibration for the analyser, it is necessary to obtain a consensus value representative of an uncalibrated mass to charge ratio value from the raw data for ions of each charge state for each calibrant species. This consensus value may be a provisional mass to charge ratio value, a frequency F value or a value of 1/F². These consensus values may be obtained by histogramming the raw data onto a predetermined axis. For example, the predetermined axis may be provisional mass to charge ratio, 1/F², or frequency (F) and the raw data may be histogrammed into suitably closely spaced bins along this axis according to the provisional mass to charge ratio, 1/F², or frequency value measured for each ion. The resulting histogram therefore represents a spectrum of ion abundance as a function of the measured provisional mass to charge ratio, 1/F², or frequency for the ions. This spectrum can then be subjected to a peak detection or peak locating algorithm in order to detect or locate ion peaks corresponding to ions of different charge states for the one or more calibrant species. Peaks corresponding to different, e.g. adjacent, charge states of a calibrant species may partially overlap, and so it may therefore be necessary or advantageous to utilise a deconvolution algorithm in order to extract accurate peak positions along the predetermined axis.

However, it has been recognised that when performing such histogramming, ions having very different masses may be allocated to the same bin, or closely spaced bins, on the predetermined axis. As such, a peak in the spectrum that appears to relate to one type of ion may actually be made up of ions having significantly different masses, and this can lead to the mass to charge ratio calibration being less accurate. For example, in a sample containing a protein such as glutamate dehydrogenase (GDH), the protein exists primarily in solution as a hexamer (i.e. comprising six copies of the GDH protein), whereas in a concentrated solution multiples of this are also observed. For instance, a dimer of the hexamers, which has 12 copies of GHD may be present, or a trimer of the hexamers having 18 copies of GHD may be present etc. Since it is possible for an ion of the dimer to carry twice as much charge as an ion of the monomer, an ion of the dimer may have substantially the same mass to charge ratio as an ion of the monomer. This can be seen in FIG. 3B, where some of the ions of GDH in box 10, which are dimers of the hexamer, have provisional mass to charge ratios that overlap with those of some of the ions of GDH in box 12, which are monomers of the hexamer. As such, during histogramming, ions of both the monomer and dimer may be allocated to the same bin even though they have very different masses and charge states.

It has been recognised that in order to avoid this problem it may be preferable to select only some of the raw data for histogramming in order to ensure, as far as possible, that only the desired ions contribute to the spectrum that is subjected to the peak detection or peak locating. As described above, e.g. in relation to FIGS. 3A-3C, a data pair is measured for each ion that is detected, where the data pair comprises a value representative of the mass to charge ratio of the ion (such as provisional mass to charge ratio, 1/F², or frequency F) and a value representative of the charge of the ion, such as the magnitude/amplitude. The step of selecting raw data for inclusion in the histogram may comprise only selecting data points that have certain combinations of values representing mass to charge ratio and charge. Referring to FIG. 3B for example, only the raw data within either box 10 or box 12 may be selected for inclusion in the histogram. This selection step may therefore be considered to be equivalent to only selecting raw data that falls within one or more specific zones of a map of the raw data plotted as measured magnitude/amplitude against a measured value representing mass to charge ratio. Each of the one or more selected zones may be rectangular, e.g. as shown by either box 10 or box 12 in FIG. 3B. However, it is contemplated that each zone may be any other shape. In any event, the selected one or more zones is defined in such a way as to substantially separate the ions desired to be histogrammed from other ions, such as background ions, ions having incorrectly measured properties, or ions corresponding to another calibrant species. Preferably, the selected zone is a single region that is approximately a parallelogram and that encompasses ions of a calibrant species having a range of different charge states.

As described above, once the raw data has been histogrammed, the resulting spectrum can be subjected to peak detection or peak locating using an algorithm, which may comprise a deconvolution algorithm to extract accurate peak positions. It is necessary to supply the peak detecting/locating and deconvolution algorithm with a peak shape, and a peak width or information regarding plausible peak widths such as a prior probability distribution over peak widths. This helps to avoid spurious peak detections and to ensure that all relevant peaks are detected or located.

However, as mentioned above, it is often the case that calibrant ions carry a significant amount of additional mass due to solvent or other adducts being coupled to them. It has been recognised that this affects the shape, width and position of the peaks for the ions, resulting in less accurate calibration when conventional approaches are used.

In order to solve this, embodiments of the present invention use a probabilistic approach to peak detection/locating and deconvolution. As described above, the amount of additional mass that is coupled to a given calibrant ion may be unknown and hence the peak width, and optionally one or more peak shape parameter, may be treated as parameters having unknown values in the peak detection/locating step. It can be assumed, to a good approximation, that the peak width will be the same for all charge states of a given calibrant species. This allows the data corresponding to a calibrant species with actual mass M (i.e. the mass of the calibrant ion including any unknown additional mass) and multiple charge states z to be modelled as a sum of contributions over the charge states. Assuming, as an example, that the peak shape of each peak is Gaussian, the data can be modelled as:

$$f ( x ) = {\sum }_{z = {z}_{min}}^{{z}_{max}} \frac{{A}_{z}}{\sqrt{2 π} σ} exp ( - \frac{{( x - g \frac{M}{z} )}^{2}}{2 {σ}^{2}} )$$

where x is the value on the uncalibrated (i.e. provisional) mass to charge ratio axis, A_{z} is the abundance of ions having a given one of the charge states z, and σ is the peak width parameter (as a standard deviation). It will be appreciated that the values of A_{z} and σ in the model are unknown. If the data are sufficiently high resolution enough to warrant it, the mass of the charge carrier, which is usually a proton, can be included explicitly in the model. In this case, M would be replaced by M+zH⁺, where H⁺ is the mass of a proton. However, otherwise, the product gM in the equation above can be treated as a single parameter μ that is to be fitted, so that the unknowns in the model are A_{z}, σ, μ, and M. The unknown abundance parameter A_{z} and the peak width parameter σ are usually not of primary interest, so they can optionally be integrated over, e.g. numerically, using the well-known process of marginalisation.

A likelihood function may be used to measure how well the model fits to the histogrammed data. The likelihood may be taken to be Poisson distribution with a rate proportional to f(x). A value for μ may be inferred together with its uncertainty and then used to produce the input data dᵢⱼ±σᵢⱼ, which are the inferred mass to charge ratio peak values (together with their uncertainties) that are to be used in the calibration procedure that has been described above. For a number i=1 . . . N of different calibrant species having a range of known charge states zᵢⱼ, where i indexes the calibrant species and j indexes the charge state, the data dᵢⱼ for the ith calibrant may be expressed as:

$${d}_{i j} = \frac{{μ}_{i}}{{z}_{i j}}$$

A separate histogrammed data set may be produced for ions of each calibrant species. It is to be noted that the individual calibrant datasets may be histogrammed differently (e.g. different bin sizes), the calibrants may have different peak width parameters σᵢ.

It will be appreciated that although the model has been described as being fitted to data that has been histogrammed along an axis representing provisional mass to charge ratio, the model may alternatively be fitted to the two-dimensional map of the raw data plotted as measured amplitude against a measured value representing mass to charge ratio. In this case, an additional fixed or variable peak width parameter corresponding to the variability in charge state measurement is included in the model.

In order to perform charge state calibration of the spectrometer, charge states may be assigned to the calibrant ions, e.g. at the outset of the calibration procedure. The charge state calibration involves locating charge state peaks in the data obtained by mass analysing the calibrant ions. A linear model may be used to relate the assigned charge states to the positions of their respective charge state peaks on a charge-related axis of the data. As explained above, the charge (z) of an ion may be represented by z=c₀+c₁A, where c₀ and c₁ are constants and A is the magnitude or amplitude of the portion of the signal corresponding to that ion. Accordingly, an assigned charge state z is related to the location of its respective charge-state, on the charge-related axis, by the parameters c₀ and c₁. For example, referring to FIG. 3B, the assigned charge state of a peak is related to the position of the peak on the y-axis by parameters c₀ and c₁. The method determines the values of the model parameters c₀ and c₁ that fit the model to the data, based on the charges that have been assigned to the peaks. These values may then be used as calibration parameters that relate a magnitude/amplitude of an ion signal to its charge state.

The charge states that are assigned in the above process may be known (e.g. previously determined) charge states, or they may be estimated charge states. If there is uncertainty about what the actual charge states of the ions are then different combinations of charge states may be assigned to the peaks and the quality of the resulting charge calibrations may be compared so as to determine which combination of charge states is most likely to be the correct charge states. The corresponding parameters c₀ and c₁ may be determined to be the correct calibration parameters. For each of the different combinations of charge states, the mass to charge ratio calibration may also be evaluated. As such, it may be preferred to perform the charge-state and mass to charge ratio calibrations in a single overall calibration process.

According to an embodiment of the present invention, the step of locating the charge-state peaks may involve histogramming the raw data onto a predetermined axis that represents charge state. For example, the predetermined axis may be magnitude/amplitude of the signal, and the raw data may be histogrammed into suitably closely spaced bins along this axis according to the amplitude/magnitude value measured for each ion. The locations of the charge state peaks may then be determined from the histogrammed spectral data, e.g. in a corresponding manner to that described above for the histogrammed mass to charge ratios. The locations of these charge state peaks, which represent the magnitudes/amplitudes A described above, are then used together with the assigned charge states z so as to determine the calibration parameters c₀ and c₁.

However, as will be appreciated from FIG. 3B, for example, even if the filtered raw data in box 10 is histogrammed in the charge related dimension (y-axis in FIG. 3B) then the charge state peaks may overlap significantly and so histogramming in that dimension alone may not yield useful information. Although trapping and analysing ions in the ion trap for longer leads to higher charge resolution and eventually may make this histogramming useful, this would result in it taking a relatively long time to obtain the calibration data.

In order to overcome this problem, embodiments of the invention select a subset of the raw data in box 10, for example, for use in determining the locations of the charge state peaks. More specifically, only raw data having mass to charge ratio related values that are within a window of each mass to charge ratio peak that has been located are used to determine the locations of the charge state peaks. The width of each window may be set to be smaller than the width of the mass to charge ratio peaks, at least where these peaks overlap, so as that the raw data that is selected for each mass to charge ratio peak is likely to relate to a single charge state. Each window is therefore associated with a respective charge state peak, and the selected raw data for any given window is assigned the charge state of its respective charge state peak. The selected raw data relating to any given charge state peak is then used to determine the location of that peak in the charge-related dimension, e.g. on the magnitude/amplitude axis, so as to determine a consensus charge-related value for the peak, optionally together with its uncertainty. The consensus charge-related value may be obtained by averaging the measured charge related values for the selected raw data in the window. Alternatively, the consensus charge-related values may be obtained by using another technique to locate the positions of these individual charge peaks in the charge related dimension. As described above, the locations of the charge state peaks, which represent the magnitudes/amplitudes A described above, are then used together with their respective assigned charge states z so as to determine the calibration parameters c₀ and c₁.

Uncertainties in the charge calibration parameters, including correlations between them, may be used to determine uncertainties in calibrated charge measurements.

While the data is being modelled so as to locate charge state peaks (and/or the mass to charge ratio peaks, as described above), definitive charge states may not be assigned to individual ions. This is because different peaks may overlap with each other and so there can be ambiguity as to which individual ions relate to which peaks.

It is recognised that the amount of additional mass that may couple to a calibrant ion is related to the charge state of the ion. More specifically, the charge state of an ion can influence its structure and, in turn, the amount of additional mass that can couple to it. The charge dependence of the additional mass may therefore be parameterised and one or more corresponding parameters may be added to the various models described above as part of the calibration procedure. For example, a linear dependence of additional mass on charge state for an i'th calibrant species may be contemplated, as follows:

$${δ}_{i} = {δ}_{i 0} + {c}_{i} z$$

where δᵢ₀ is an additional mass parameter that is independent of charge state, and cᵢ is an additional a priori unknown parameter for each calibrant species i.

Although embodiments have been described above in which the charge states of the calibrant ions are known, it is contemplated that the techniques described above may also be used when the charge states are uncertain or unknown. In such embodiments, parameters representing the unknown charge states are included in the model used to fit the data. Different charge state assignments result in different inferences regarding the mass to charge ratio calibration parameter g. Charge state and mass to charge ratio calibration may therefore be advantageously carried out simultaneously by adding two additional unknown calibration parameters z₀ and a to the model, which describe the linear relationship between measured magnitude and charge as z=z₀+aI, where I is the measured magnitude. Equivalently, this may be framed in terms of a linear modification of a provisional charge calibration.

Since charge assignments are quantised, this technique involves comparing the overall fit of the model to the data that results from combinations of discrete charge state assignments for each calibrant species. This applies both to the main calibration procedure described above, in which the evidence Pr(d) becomes the quantity that would be compared between sets of charge state assignments, and to the peak fitting technique described above. Various sets of charge state assignments may be tried in sequence or as part of an overall Markov Chain Monte Carlo exploration procedure. The relationship between charge states for a given calibrant will usually remain unchanged, so that a change in proposed charge state assignment will usually consist of adding a small integer value (positive or negative) to all charge states of a given calibrant.

In order to obtain the raw calibration data described herein, it is preferred that a relatively low number of ions are trapped in the ion trap at any one time during analysis, so as to prevent distortions arising from processing of congested data and/or to reduce the likelihood of ion-ion interactions within the ion trap that would distort the measurements. In order to do this, it is required that ions are arriving at the analyser at a relatively low rate when the ion trap is opened to admit the calibrant ions. The spectrometer may therefore comprise an ion attenuator that attenuates the ions travelling towards the analyser so that the average number of ions admitted into, and trapped in, the ion trap during the calibration mode is below a pre-selected threshold value. The number of ions detected in trapping events may be monitored, and the spectrometer may be configured to control the level of attenuation that the ion attenuator performs in response to the detected rate, so that the average number of ions admitted into, and trapped in, the ion trap during the calibration mode is below the pre-selected threshold value. The threshold value could, for example, be 10 ions per trapping event, 1 ion per trapping event or 0.1 ions per trapping event.

Additionally, or alternatively, to attenuating ions, the spectrometer may monitor the number of ions detected in trapping events and may be configured to control the duration of time during which the ion trap admits ions so that the average number of ions admitted into, and trapped in, the ion trap during the calibration mode is below the pre-selected threshold value.

FIG. 7 shows an embodiment of a mass spectrometer according to the present invention. The spectrometer comprises an ion source 20 and a first ion guide 21 arranged in a first vacuum chamber 22. The first ion guide may be in the form of an ion tunnel ion guide having an ion funnel at its downstream end, although other forms of ion guide may be used instead or as well. The first vacuum chamber may be maintained at a pressure or, for example, 5 mbar. It is contemplated that alternatively the ion source may be an atmospheric pressure ion source arranged upstream of the first vacuum chamber. An ion attenuation device 23 is provided in a second vacuum chamber 24 that is maintained at a lower pressure than the first vacuum chamber, such as at 10⁻⁵ mbar.

The ion attenuation device 23 may comprise an ion attenuator 25 within an ion guide 26. The upstream end of the ion attenuation device may be mounted to the differential pumping aperture 27 between the first and second vacuum chambers so as to form a gas tight seal between the ion attenuation device and the wall between the two vacuum chambers. The circumference of the ion attenuation device may be sealed in a gas tight manner for at least a portion of its length starting from the upstream end. As such, the gas pressure within said at least a portion of the ion attenuation device may be maintained higher than the pressure in the rest of the second vacuum chamber, since gas flows from the higher pressure first vacuum chamber into the ion attenuation device. However, it is contemplated that the ion attenuation device is not sealed to the differential pumping aperture and that it may not be sealed around its circumference.

A CDMS mass analyser 28, such as that shown in FIG. 1, is provided in a final vacuum chamber 29. If the analyser requires a very low pressure to be able to operate efficiently, then one or more additional vacuum chambers may be provided between the second vacuum chamber and the final vacuum chamber so as to enable the final vacuum chamber to be pumped down to the desired pressure. For example, the analyser 28 may be maintained at a pressure of ≤10⁻⁸ mbar or 10⁻⁹ mbar. In the depicted embodiment third and fourth vacuum chambers 30,31 are provided between the second vacuum chamber and the final vacuum chamber. Each of the third and fourth vacuum chambers has an ion guide therein for guiding ions through it to the next vacuum chamber. Additional, non-illustrated, ion-optics may be provided as well, such as DC lenses. By way of example, the third vacuum chamber may be maintained at a pressure of approximately 10⁻⁵ mbar and the fourth vacuum chamber may be maintained at a pressure of approximately 10⁻⁷ mbar. The ion guide 32 in the third vacuum chamber and/or the ion guide 33 in the fourth vacuum chamber may have an axial DC electric field maintained across it so as to urge ions therethrough in the downstream direction. This may be achieved, for example, by the ion guide in the third and/or fourth vacuum chamber being an axially segmented ion guide having a voltage supply that applies different DC voltages to different axial segments. As the pressure reduces there may be less necessity apply an axial DC electric field across the ion guide and as such the ion guide in the fourth vacuum chamber may not provide this feature, i.e. it may not be axially segmented.

In operation, a voltage such as DC voltage is applied to one or more electrode of the ion attenuator such that it repeatedly switches between a high attenuation mode and a low attenuation mode as the ions pass through it. In the high attenuation mode, the voltages applied to the electrodes of the ion attenuator cause the ions passing through the ion attenuator to be deflected and lost, such as by causing them to strike an electrode or other surface and be electrically neutralised. In the low attenuation mode, the voltages applied to the electrodes of the ion attenuator cause the ions passing through the ion attenuator to be deflected and lost at a lower rate than in the high attenuation mode. For example, ions may substantially not be deflected or attenuated by the ion attenuator in the low attenuation mode, but rather may simply pass downstream through the ion attenuator. As such, the pulsed ion attenuator intermittently transmits groups (e.g. discrete packets) of ions in the high transmission modes. The ion attenuation device may be maintained at a relatively high pressure so as to cause the ions transmitted by the ion attenuator to collide with background gas molecules within the ion attenuation device and cause the groups of ions (e.g. ion packets) transmitted by the ion attenuator in the high transmission modes to be spatially dispersed in the axial direction and merge with each other as the ions travel downstream through the ion attenuation device. For example, at least the portion of the ion attenuation device arranged downstream of the ion attenuator may be arranged at a pressure of ≥10⁻³ mbar.

It is contemplated that two or more ion attenuators 10 may be arranged within the ion guide 6. This may be used to attenuate the ion beam to a relatively high level. For instance, a single ion attenuator may attenuate the ions such that approximately 1% of the ion beam is transmitted, whereas two ion attenuators may attenuate the ions such that approximately 0.01% of the ion beam is transmitted. The use of multiple ion attenuators within the ion guide is particularly advantageous in charge detection mass spectrometry, where as it allows the transmission of ions at a very low rate, and so enables control of the ion arrival rate over a wide dynamic range.

Embodiments have been described in which the ion attenuator attenuates ions by being pulsed between high and low attenuation modes. It will be appreciated that the spectrometer may vary the rate of ion attenuation by varying the rate at which the modes are switched between. However, it is contemplated that the ion attenuator may not be a pulsed ion attenuator that switches between two modes, but may instead vary the level of attenuation in other manners, such as by varying the amount that the ion beam is defocussed.

Although embodiments have been described above in which the additional mass parameters and the peak width or peak shape parameters are not of primary importance and may be “marginalised” (e.g. analytically or numerically), it is recognised herein that they are useful in identifying problems with the analytical system and sample preparation. For example, insufficient sample clean up during sample preparation, problems with the electrospray process, insufficient desolvation or insufficient declustering of ions in the spectrometer can all lead to an increase in the additional mass that is coupled to a calibrant ion and/or to a change in the peak width and/or peak shape detected for some or all of the calibrant species. Accordingly, the models described above may be used and the values of the additional mass parameters and/or peak width and/or peak shape parameters may be determined for some or all of the calibrant species. These determined values may be compared to expected values, and limits on these parameters can be established through experience and repeated measurements for particular calibrants, and violation of these limits could, for example, prompt a warning or advice to the user or an instrument service request.

Although the present invention has been described with reference to various embodiments, it will be understood by those skilled in the art that various changes in form and detail may be made without departing from the scope of the invention as set forth in the accompanying claims.

For example, although embodiments have been described in which single-parameter mass to charge ratio calibration is performed, and in which linear two-parameter charge calibration is performed, other forms for the calibration may be considered such as higher order polynomials, splines and so on. It is also contemplated that only one parameter may be used for calibration, i.e. z=c₁A, where z is the charge state, A is the amplitude/magnitude, and c₁ is a constant.

Although embodiments have been described above for calibrating a charge detection mass spectrometer, the techniques described herein may alternatively be used for calibrating other types of mass spectrometer. For example, the techniques described herein may be used for mass to charge ratio calibration in a quadrupole, Time of Flight or Orbitrap mass spectrometer.

In such mass spectrometers it is known to use a well determined mass series such as Caesium Iodide (CsI) clusters for calibration. However, it can be challenging to produce a sufficiently strong signal for these clusters at high mass to charge ratios whilst using the same ionisation source that is used to produce the analyte ions. Embodiments of the present invention may use conventional calibrants (e.g. CsI) and a conventional calibration process for calibration at relatively low mass to charge ratio values, and may a calibration process that employs a model as described herein for calibration at higher mass to charge ratio values. Calibrants of low mass to charge ratio tend to have relatively insignificant additional masses coupled to them, whereas higher mass to charge ratio calibrants tend to have relatively significant additional masses coupled to them, which the models described herein are able to account for in the calibration process, as discussed above. This enables the same ion source to be used to ionise the analyte and also to generate calibration ions having mass to charge ratios across the desired range.

1. A method of calibrating a charge detection mass spectrometer, comprising:
analysing ions of one or more calibrant species using said charge detection mass spectrometer so as to obtain data representative of the mass to charge ratios of the ions, where a minimum mass is known for an ion of each calibrant species; and
using said data, said minimum mass, and an additional mass value representing a mass that may be attached to each of the one or more calibrant species during said analysing to determine a calibration parameter that relates data obtained when analysing a given ion species using said charge detection mass spectrometer to its mass to charge ratio.

2. The method of claim 1, where the minimum mass for each of the calibrant species is its theoretical mass value determined from its molecular structure.

3. The method of claim 1 or 2, wherein each of the one or more calibrant species is a protein or peptide.

4. The method of any preceding claim, wherein said analysing ions of one or more calibrant species comprises analysing ions of multiple different calibrant species so as to obtain said data.

5. The method of any preceding claim, wherein at least one charge state of the ions of each calibrant species analysed is known, and wherein the at least one charge state is used, along with the corresponding minimum mass, additional mass value, and data from said analysing step to determine the calibration parameter.

6. The method of any preceding claim, where all ions of a given calibrant species are considered to have the same additional mass; and/or
where ions of different calibrant species are considered to have respective additional masses that are different from each other.

7. The method of any preceding claim, wherein said analysing ions comprises causing each ion to oscillate in an ion trap and measuring the frequency at which the ion oscillates so as to obtain said data representative of the mass to charge ratio of the ion.

8. The method of claim 7, wherein said measured data is said frequency, wherein said mass to charge ratio is equal to the product of a constant k and the inverse of the square of said frequency, and wherein said calibration parameter is said constant k.

9. The method of claim 7, wherein said mass to charge ratio is equal to the inverse of a first constant g multiplied by a second constant k₀, multiplied by the inverse of the square of said frequency, and where the data is a value determined based on said frequency and said second constant k₀, and where said calibration parameter is said constant g.

10. The method of any preceding claim, comprising:
providing a model that relates said data to parameters representing: (i) said minimum mass of each calibrant species, (ii) said additional mass for each calibrant species, (iii) at least one charge state for ions of each calibrant species, and (iv) said calibration parameter;
specifying a function that provides a likelihood, or goodness of fit, of the model to the data for a given set of values for said parameters; and
using said model, said function and said data to determine a value of the calibration parameter, optionally together with a value for the uncertainty associated with this determined value of the calibration parameter.

11. The method of claim 10, comprising using a Bayesian approach to determining the calibration parameter.

12. The method of claim 10 or 11, wherein the value of the parameter representing said additional mass for each calibrant species is unknown, and a first prior probability distribution is provided for this parameter.

13. The method of any one of claims 10 to 13, wherein the value of the calibration parameter is unknown, and a second prior probability distribution is provided for this parameter.

14. The method of any claim 13, comprising determining a joint probability distribution for the data and the parameters representing said additional mass for each calibrant species and said calibration parameter.

15. The method of any claim 14, comprising removing the parameters representing said additional mass for each calibrant species from the joint probability distribution by integrating over them so as to obtain an expression for a modified joint probability distribution in which the only parameter having an unknown value is said calibration parameter.

16. The method of any claim 15, wherein the step of using said model, said function and said data to determine a value of the calibration parameter comprises extracting inferences about the calibration parameter from the modified joint probability distribution.

17. The method of any claim 16, wherein said extracting inferences about the calibration parameter from the modified joint probability distribution comprises:
(i) using the modified joint probability distribution directly to numerically calculate a representative inferred value for the calibration parameter together with a measure of uncertainty; or
(ii) sampling values of the calibration parameter from the modified joint probability distribution.

18. The method of any one of claims 10-17, comprising using said model, said function and said data to generate an inferred value for each of the parameters representing said additional mass for each calibrant species, optionally together with a value for the uncertainty associated with this determined value of additional mass.

19. A method of charge detection mass spectrometry comprising:
providing a charge detection mass spectrometer;
determining a calibration parameter that relates data obtained by the mass spectrometer when analysing a given ion species to its mass to charge ratio by performing a method as claimed in any preceding claim;
analysing at least one ion of one or more further ion species in the mass spectrometer so as to obtain data representative of the mass to charge ratio of the at least one ion; and
determining the mass to charge ratios of said at least one ion using said data for said at least one ion and said calibration parameter.

20. The method of claim 19, further comprising using the mass spectrometer to measure the charge states of said at least one ion, and determining the mass of each ion from the mass to charge ratio and charge state determined for it.

21. A computer implemented method for calibrating a charge detection mass spectrometer comprising:
receiving data representative of the mass to charge ratios of ions of one or more calibrant species, along with a known minimum mass for the ions of each calibrant species; and
using said data, said minimum mass, an and additional mass value representing a mass that may be attached to each of the one or more calibrant species during said analysing to determine a calibration parameter that relates data obtained when analysing a given ion species using said charge detection mass spectrometer to its mass to charge ratio.

22. A charge detection mass spectrometer comprising:
an analyser for analysing ions of one or more calibrant species so as to obtain data representative of the mass to charge ratios of the ions; and
control circuitry configured to control the mass spectrometer to:
access known values for a minimum mass for the ions of each of said calibrant species; and
use said data, said minimum mass, and an additional mass value representing a mass that may be attached to each of the one or more calibrant species during said analysing to determine a calibration parameter that relates data obtained when analysing a given ion species using said charge detection mass spectrometer to its mass to charge ratio.

23. A method of calibrating a charge detection mass spectrometer, comprising:
analysing ions of one or more calibrant species using said charge detection mass spectrometer so as to obtain a data pair for each ion that is detected, where the data pair comprises a first value related to the mass to charge ratio of the ion and a second value related to the charge of the ion;
arranging the data pairs as spectral data that represents the abundance of ions as a function of the first value related to mass to charge ratio; and
performing mass to charge ratio peak locating on said spectral data by using a model that relates said spectral data to a set of parameters.

24. The method of claim 23, wherein the model relates said spectral data to a set of parameters that includes one or more parameters that represent the mass for each ion of each calibrant species and a parameter that relates the first value measured by the spectrometer to a mass to charge ratio value.

25. The method of claim 23 or 24, wherein each of said one or more calibrant species has ions of multiple different charge states that are analysed in said analysing step.

26. The method of claim 23, 24 or 25, comprising:
specifying a function that provides a likelihood, or goodness of fit, of the model to the spectral data for a given set of values for said parameters; and
using said model, said function and said spectral data to determine a set of values for said parameters that fit the model to the spectral data.

27. The method of any one of claims 23-26, wherein the model relates said spectral data to parameters representing: the abundance of ions for each charge state of one of said calibrant species; and/or the mass to charge ratio peak width for each charge state of said one of the calibrant species.

28. The method of any one of claims 23 to 27, further comprising:
arranging the data pairs as spectral data that represents the abundance of ions as a function of the second value related to charge state; and
performing charge state peak locating on said spectral data by using a model that relates said spectral data to one or more parameters.

29. The method of claim 28, wherein the model also relates said spectral data to a parameter representing the mass of each charge carrier that gives rise to the charge state, such as the mass of a proton.

30. The method of any one of claims 23 to 29, wherein each step of arranging the data pairs as spectral data comprises selecting only a subset of the data pairs that have certain combinations of said first and second values, and arranging only these data pairs as the spectral data.

31. The method of claim 30, wherein said certain combinations of said first and second values are selected so as to include only ions of a single calibrant species, optionally where the ions have multiple different charge states.

32. The method of claim 30 or 31, wherein the selection step comprises selecting only data pairs that fall within a single zone, or within multiple discrete zones, of a two-dimensional map of the data pairs, where one dimension of the map is the first value related to mass to charge ratio and the other dimension of the map is said second value related to the charge of the ion.

33. The method of claim 32, where each of the zones has a shape that is substantially a parallelogram, such as an elongated rectangle.

34. The method of any one of claims 30 to 33, comprising:
performing said step of selecting only a subset of the data pairs multiple times so as to obtain multiple different subsets of data pairs that include ions of different respective calibrant species, so as to thereby obtain different sets of spectral data for the different respective calibrant species;
providing a model for each set of spectral data that relates that spectral data to said parameters;
specifying a function that provides a likelihood, or goodness of fit, of each model to its respective set of spectral data for a given set of values for said parameters; and
for each set of spectral data, using its respective model and function to determine a set of values for said parameters that fit the model to the spectral data.

35. The method of any one of claims 23 to 34, wherein the step of arranging the data pairs as spectral data comprises histogramming the data pairs onto an axis representing said first values such that the histogrammed data represents a spectrum of ion abundance as a function of the first value related to mass to charge ratio; and where the model relates said histogrammed data to said parameters.

36. The method of any one of claims 23 to 34, wherein the step of arranging the data pairs as spectral data comprises arranging the data into a two-dimensional map having a first dimension representing the first value and a second dimension representing the second value;
where the model further includes a parameter that represents the peak width, in the second dimension, of each charge state; and
where the model relates said map of data to said parameters.

37. A method of calibrating a charge detection mass spectrometer, comprising:
analysing ions of one or more calibrant species using said charge detection mass spectrometer so as to obtain data related to the mass to charge ratios and charges of the ions; and
a) determining charge state related peak positions for the ions by using a model that relates said data to one or more parameters; and/or
b) inferring mass to charge ratio related peak positions for the ions by using a model that relates said data to one or more parameters.

38. A method of calibrating a charge detection mass spectrometer, comprising:
analysing ions of one or more calibrant species using said charge detection mass spectrometer so as to obtain data representative of the charge states of the ions; and
using a model that relates said data to calibration parameters that relate data obtained when analysing a given ion using said charge detection mass spectrometer to its charge state.

39. The method of claim 38, wherein said analysing ions comprises causing each ion to oscillate in an ion trap, measuring the frequency at which the ion oscillates so as to obtain a signal, and measuring the magnitude of the signal so as to obtain said data representative of the charge state of the ion.

40. The method of claim 39, wherein said charge state is equal to the sum of a first constant with the product of a second constant and said magnitude, and wherein said calibration parameters are said first and second constants.

41. The method of any one of claims 38-40, comprising:
specifying a function that provides a likelihood, or goodness of fit, of the model to the data for a given set of values for said parameters; and
using said model, said function and said data to determine values of the calibration parameters, optionally together with a value for the uncertainty associated with these determined values of the calibration parameters.

42. A method of calibrating a charge detection mass spectrometer, comprising:
analysing ions of one or more calibrant species using said charge detection mass spectrometer so as to obtain a data pair for each ion that is analysed, where the data pair comprises a first value related to the mass to charge ratio of the ion and a second value related to the charge of the ion;
selecting only a subset of the data pairs that have certain combinations of said first and second values;
arranging the subset of data pairs as spectral data that represents the abundance of ions as a function of the first value related to mass to charge ratio, and optionally also as a function of the second value related to charge state; and
performing peak locating on said spectral data.

43. A method of mass spectrometry comprising:
analysing ions of one or more ion species using a charge detection mass spectrometer so as to obtain data representative of the mass to charge ratios of the ions;
providing a model that relates said data to parameters including a known minimum mass of each ion species, and an additional mass that may be attached to an ion of each ion species during said analysing;
specifying a function that provides a likelihood, or goodness of fit, of the model to the data for a given set of values for said parameters;
using said model, said function and said data to calculate a value of the additional mass that fits said data; and
determining if the calculated value of additional mass differs from a pre-selected value for the additional mass by more than a threshold amount, or falls outside of a preselected range of values for the additional mass.

44. The method of claim 43, wherein when the calculated value differs from the pre-selected value by more than a threshold amount, or falls outside of the preselected range of values, then the spectrometer triggers an output.

45. The method of claim 44, wherein the output is an alert, such as an alert that the spectrometer requires maintenance and/or a sample being analysed has not been prepared correctly.

46. A method of mass spectrometry comprising:
analysing ions of one or more ion species using a charge detection mass spectrometer so as to obtain a data pair for each ion that is detected, where the data pair comprises a first value related to the mass to charge ratio of the ion and a second value related to the charge of the ion;
arranging the data pairs as spectral data that represents the abundance of ions as a function of the first value related to mass to charge ratio; and
providing a model that relates said spectral data to a set of parameters that includes parameters representing the mass to charge ratio peak width and/or peak shape for each charge state of said one of the ion species;
specifying a function that provides a likelihood, or goodness of fit, of the model to the spectral data for a given set of values for said parameters;
using said model, said function and said spectral data to calculate the mass to charge ratio peak width and/or peak shape that fits the data; and
determining if the calculated peak width and/or peak shape differs from a pre-selected peak width and/or peak shape.

47. The method of claim 46, wherein when the calculated peak width and/or peak shape differs from a pre-selected peak width and/or peak shape by more than a threshold amount, or falls outside of a preselected range of values for the peak width and/or a preselected range of peak shapes, then the spectrometer triggers an output.

48. The method of claim 47, wherein the output is an alert, such as an alert that the spectrometer requires maintenance and/or a sample being analysed has not been prepared correctly.

49. A method of mass spectrometry comprising:
analysing ions of one or more calibrant ion species using a charge detection mass spectrometer by admitting multiple ions into an ion trap, trapping these ions simultaneously and causing them to oscillate in the ion trap, and measuring the frequency at which each ion oscillates so as to obtain a value related to its mass to charge ratio;
wherein ions travelling to said ion trap are attenuated by an ion attenuator so as to restrict the number of ions admitted into and simultaneously trapped in the ion trap.

50. The method of claim 49, wherein the spectrometer performs multiple different trapping events during which the ion trap traps and analyses different respective ions, wherein the spectrometer detects the number of ions trapped during one or more of the trapping events; and
(i) wherein the spectrometer controls the level of attenuation that the ion attenuator performs in response to the detected number of ions, and based on a pre-selected target value for the number of ions desired to be admitted into and simultaneously trapped in the ion trap, so as to control the number of ions admitted into and simultaneously trapped in the ion trap in a subsequent trapping event; and/or
(ii) wherein the spectrometer controls the duration of time during which the ion trap admits ions in response to the detected number of ions, and based on a pre-selected target value for the number of ions desired to be admitted into and simultaneously trapped in the ion trap, so as to control the number of ions admitted into and simultaneously trapped in the ion trap in a subsequent trapping event.

51. A method of calibrating a mass spectrometer, comprising:
analysing ions of one or more calibrant species using said mass spectrometer so as to obtain data representative of the mass to charge ratios of the ions, where a minimum mass is known for an ion of each calibrant species; and
using said data, said minimum mass, and an additional mass value representing a mass that may be attached to each of the one or more calibrant species during said analysing to determine a calibration parameter that relates data obtained when analysing a given ion species using said mass spectrometer to its mass to charge ratio.

52. A method of calibrating a mass spectrometer, comprising:
analysing ions of one or more calibrant species using said mass spectrometer so as to obtain data for each ion that is detected, where the data comprises a first value related to the mass to charge ratio of the ion;
arranging the data as spectral data that represents the abundance of ions as a function of the first value related to mass to charge ratio; and
performing peak locating on said spectral data by using a model that relates said spectral data to a set of parameters that, optionally, includes one or more parameters that represent the mass for each ion of each calibrant species and a parameter that relates a first value measured by the spectrometer to a mass to charge ratio.

53. A method of calibrating a mass spectrometer, comprising:
analysing ions of one or more calibrant species using said mass spectrometer so as to obtain data related to the mass to charge ratios and charges of the ions; and
a) determining charge state related peak positions for the ions by using a model that relates said data to one or more parameters; and/or
b) inferring mass to charge ratio related peak positions for the ions by using a model that relates said data to one or more parameters.

54. A method of calibrating a mass spectrometer, comprising:
analysing ions of one or more calibrant species using said mass spectrometer so as to obtain data representative of the charge states of the ions; and
using a model that relates said data to calibration parameters that relate data obtained when analysing a given ion using said mass spectrometer to its charge state.

55. A method of calibrating a mass spectrometer, comprising:
analysing ions of one or more calibrant species using said spectrometer so as to obtain a data pair for each ion that is analysed, where the data pair comprises a first value related to the mass to charge ratio of the ion and a second value related to another physicochemical property, such as mobility;
selecting only a subset of the data pairs that have certain combinations of said first and second values;
arranging the subset of data pairs as spectral data that represents the abundance of ions as a function of the first value related to mass to charge ratio, and optionally also as a function of the second value; and
performing peak locating on said spectral data.

56. A method of mass spectrometry comprising:
analysing ions of one or more ion species using a mass spectrometer so as to obtain data representative of the mass to charge ratios of the ions;
providing a model that relates said data to parameters including a known minimum mass of each ion species, and an additional mass that may be attached to an ion of each ion species during said analysing;
specifying a function that provides a likelihood, or goodness of fit, of the model to the data for a given set of values for said parameters;
using said model, said function and said data to calculate a value of the additional mass that fits said data; and
determining if the calculated value of additional mass differs from a pre-selected value for the additional mass by more than a threshold amount, or falls outside of a preselected range of values for the additional mass.

57. A method of mass spectrometry comprising:
analysing ions of one or more ion species using a mass spectrometer so as to obtain data representative of the mass to charge ratios of the ions;
arranging the data as spectral data that represents the abundance of ions as a function of mass to charge ratio; and
providing a model that relates said spectral data to a set of parameters that includes parameters representing the mass to charge ratio peak width and/or peak shape said one of the ion species;
specifying a function that provides a likelihood, or goodness of fit, of the model to the spectral data for a given set of values for said parameters;
using said model, said function and said spectral data to calculate the mass to charge ratio peak width and/or peak shape that fits the data; and
determining if the calculated peak width and/or peak shape differs from a pre-selected peak width and/or peak shape.

58. A method of mass spectrometry comprising:
analysing ions of one or more calibrant ion species using a mass spectrometer by admitting multiple ions into an ion trap, trapping these ions simultaneously and causing them to oscillate in the ion trap, and measuring the frequency at which each ion oscillates so as to obtain a value related to its mass to charge ratio;
wherein ions travelling to said ion trap are attenuated by an ion attenuator so as to restrict the number of ions admitted into and simultaneously trapped in the ion trap.
